(19) United States
(12) Patent Application Publication
(10) Pub. No.: US 2016/0072560 A1
(43) Pub. Date: Mar. 10, 2016

(54) RECEPTION APPARATUS, RECEPTION METHOD AND RECEPTION PROGRAM

(71) Applicants: TOKYO INSTITUTE OF TECHNOLOGY, Tokyo (JP); SHARP KABUSHIKI KAISHA, Osaka (JP)

(72) Inventors: Kazuhiko FUKAWA, Tokyo (JP); Hiroshi SUZUKI, Tokyo (JP); Katsuya KATO, Osaka-shi, Osaka (JP); Ryota YAMADA, Osaka-shi, Osaka (JP)

(73) Assignees: TOKYO INSTITUTE OF TECHNOLOGY, Tokyo (JP); Sharp Kabushiki Kaisha, Osaka-shi, Osaka (JP)

(21) Appl. No.: 14/786,101

(22) PCT Filed: Apr. 25, 2014
(86) PCT No.: PCT/JP2014/061716

§ 371 Date: Oct. 21, 2015

(30) Foreign Application Priority Data
Apr. 26, 2013 (JP) 2013-093132

(51) Int. Cl. H04B 7/04; H04B 7/08

(52) U.S. Cl. CPC H04B 7/0413; H04B 7/0842

(57) ABSTRACT

A reception apparatus that receives a transmission signal, which is transmitted from a transmission apparatus by using a MIMO transmission scheme, includes a stream selection unit that divides streams transmitted by the transmission apparatus into a first stream group and a second stream group; and a transmission candidate search unit that generates at least one candidate of the first stream group, generates a linear detection signal of the second stream group based on the candidate of the first stream group to generate transmission candidates, calculates metrics of the transmission candidates, and selects a transmission candidate, a metric of which is minimum, of the transmission candidates.

### TECHNICAL FIELD

The present invention relates to a reception apparatus, a reception method and a reception program.

The present application claims priority based on Japanese Patent Application No. 2013-093132 filed in Japan on Apr. 26, 2013, the content of which is incorporated herein.

### BACKGROUND ART

In 3GPP (3rd Generation Partnership Project), the W-CDMA technology has been standardized as the third generation cellular mobile communication technology and a service has been provided. In addition, HSDPA having a further increased communication speed has also been standardized, and a service has been provided.

In 3GPP, evolution of the third generation radio access (Evolved Universal Terrestrial Radio Access, below referred to as “EUTRA”) has been standardized and provision of a service has been started. As a communication scheme of a downlink in EUTRA, an orthogonal frequency division multiplexing (OFDM) scheme which has resistance to interference on multi-paths and is suitable for high-speed transmission has been employed. As a communication s[0002]

In recent years, as a technique for realizing large-capacity high-speed information communication, MIMO (Multiple Input Multiple Output) communication has attracted attention. FIG. 19 is a schematic view illustrating one example of the MIMO communication, in which a transmission apparatus a1 includes transmit antennas a1-1 to a1-NT and a reception apparatus b1 includes receive antennas b1-1 to b1-NR. NT denotes the number of the transmit antennas and NR denotes the number of receive antennas. With the MIMO communication, different information is able to be transmitted and received at the same time and the same frequency and an information bit rate is able to be increased significantly.

NPL 1 described below describes a reception method in the MIMO communication. As a reception method which has excellent transmission performances, MLD (Maximum Likelihood Detection) is described. The MLD is a reception method for selecting one having a minimum squared norm with respect to a received signal among possible transmission candidates. Further, as a reception method which is able to be realized with a small amount of calculation, linear detection using ZF (Zero Forcing) or MMSE (Minimum Mean Square Error) is described. The linear detection is a reception method for performing signal decision after multiplying a received signal by a weight matrix.

### CITATION LIST

### [Non-Patent Document]

NPL 1: A. J. Paulraj et al., “An Overview of MIMO Communications-a Key to Gigabit Wireless,” Proc. IEEE, vol. 92, no. 2, February 2004, pp. 198-218.

### DISCLOSURE OF THE INVENTION

### Problems to be Solved by the Invention

However, the MLD has a problem that the amount of calculation increases significantly as the number of transmit antennas or modulation order increases. Further, the linear detection has a problem that it is difficult to obtain sufficient transmission performances and effectiveness of the MIMO communication may not be utilized.

One aspect of the invention has been made in view of such circumstances, and an object thereof is to provide a reception apparatus, a reception method and a reception program by MIMO capable of realizing excellent transmission performances with a small amount of calculation.

### Means for Solving the Problems

For solving the problems described above, a reception apparatus, a reception method and a reception program according to one aspect of the invention are configured as follows.

(1) A reception apparatus according to one aspect of the invention is a reception apparatus that receives a transmission signal, which is transmitted from a transmission apparatus by using a MIMO transmission scheme, including: a stream selection unit that divides streams transmitted by the transmission apparatus into a first stream group and a second stream group; and a transmission candidate search unit that generates at least one candidate of the first stream group, generates a linear detection signal of the second stream group based on the candidate of the first stream group to generate transmission candidates, calculates metrics of the transmission candidates, and selects a transmission candidate, a metric of which is minimum, of the transmission candidates.

(2) In the reception apparatus according to one aspect of the invention, the transmission candidate search unit may generate a non-constrained linear detection signal which is a linear detection result using only the second stream group, and correct the non-constrained linear detection signal based on the candidate of the first stream group to thereby generate the linear detection signal.

(3) The reception apparatus according to one aspect of the invention may include a triangulating unit that triangulates a channel matrix by performing orthogonal conversion, in which the transmission candidate search unit may successively perform generation of the candidate of the first stream group, generation of the linear detection signal, and calculation of the metrics, and generate a candidate of the first stream group, which is a candidate of the first stream group and a cumulative metric of which is smaller than the metrics obtained by earlier successive search.

(4) In the reception apparatus according to one aspect of the invention, in a case of generating a predetermined number of candidates of the first stream group, the transmission candidate search unit ends the successive search.

(5) In the reception apparatus according to one aspect of the invention, reduction of interference may be performed for a received signal before performing reception processing.

(6) In the reception apparatus according to one aspect of the invention, the stream selection unit may select, as the first stream group, a predetermined number of streams whose amplitude after linear detection is small.

(7) In the reception apparatus according to one aspect of the invention, the stream selection unit may select, as the first stream group, a predetermined number of streams whose diagonal components of an inverse matrix of a correlation matrix of a received signal are large.

(8) In the reception apparatus according to one aspect of the invention, the stream selection unit may perform selection so that the number of candidates of the second stream group is smaller than the number of candidates of the first stream group.

(9) In the reception apparatus according to one aspect of the invention, the stream selection unit may perform selection so that the number of candidates of the second stream group is larger than the number of candidates of the first stream group.

(10) The reception apparatus according to one aspect of the invention may include an LLR calculation unit that calculates a bit log likelihood ratio, and a decoding unit that performs decoding by using the bit log likelihood ratio, in which the LLR calculation unit may calculate a bit log likelihood ratio of the second stream group based on amplitude after linear detection and a linear detection signal of the second stream group, and calculate a bit log likelihood ratio of the first stream group based on an average value of magnitude of the bit log likelihood ratio of the second stream group and the candidate of the first stream group.

(11) The reception apparatus according to one aspect of the invention may include an LLR calculation unit that calculates a bit log likelihood ratio, and a decoding unit that performs decoding by using the bit log likelihood ratio, in which the LLR calculation unit may calculate a bit log likelihood ratio of the second stream group based on amplitude after linear detection and a linear detection signal of the second stream group, generate a linear detection signal of the first stream group, and calculate a bit log likelihood ratio of the first stream group based on amplitude after linear detection and the linear detection signal of the first stream group.

(12) The reception apparatus according to one aspect of the invention may include an LLR calculation unit that calculates a bit log likelihood ratio, and a decoding unit that performs decoding by using the bit log likelihood ratio, in which the transmission candidate search unit may calculate a constrained metric of the transmission candidates, which is a minimum metric in a case where one bit in one stream is fixed, and the LLR calculation unit may calculate a bit log likelihood ratio of the second stream group based on amplitude after linear detection and a linear detection signal of the second stream group, and calculate a bit log likelihood ratio of the first stream group based on the constrained metric.

(13) The reception apparatus according to one aspect of the invention may include a triangulating unit that triangulates a channel matrix by performing orthogonal conversion, in which the transmission candidate search unit may successively perform generation of the candidate of the first stream group, generation of the linear detection signal, and calculation of the metrics, generate a candidate of the first stream group, which is a candidate of the first stream group and in which at least one of associated constrained metrics is smaller than the metrics obtained by earlier successive search, and update a constrained metric, which is a constrained metric associated with a bit sequence of the generated candidate of the first stream group and in which a metric of the generated candidate of the first stream group is smaller than the constrained metric, with the metric of the generated candidate of the first stream group.

(14) A reception method according to one aspect of the invention is a reception method for receiving a transmission signal, which is transmitted from a transmission apparatus by using a MIMO transmission scheme, including: a stream selection step of dividing streams transmitted by the transmission apparatus into a first stream group and a second stream group; and a transmission candidate search step of generating at least one candidate of the first stream group, generating a linear detection signal of the second stream group based on the candidate of the first stream group to generate transmission candidates, calculating metrics of the transmission candidates, and selecting a transmission candidate, a metric of which is minimum, of the transmission candidates.

(15) The reception method according to one aspect of the invention may include an LLR calculation step of calculating a bit log likelihood ratio, and a decoding step of performing decoding by using the bit log likelihood ratio, in which at the transmission candidate search step, a constrained metric of the transmission candidates, which is a minimum metric in a case where one bit in one stream is fixed, may be calculated and at the LLR calculation step, a bit log likelihood ratio of the second stream group may be calculated based on amplitude after linear detection and a linear detection signal of the second stream group, and a bit log likelihood ratio of the first stream group may be calculated based on the constrained metric.

(16) The reception method according to one aspect of the invention may include a triangulating step of triangulating a channel matrix by performing orthogonal conversion, in which at the transmission candidate search step, generation of the candidate of the first stream group, generation of the linear detection signal, and calculation of the metrics may be performed successively, a candidate of the first stream group, which is a candidate of the first stream group and in which at least one of associated constrained metrics is smaller than the metrics obtained by earlier successive search, may be generated, and a constrained metric, which is a constrained metric associated with a bit sequence of the generated candidate of the first stream group and in which a metric of the generated candidate of the first stream group is smaller than the constrained metric, may be updated with the metric of the generated candidate of the first stream group.

(17) In the reception method according to one aspect of the invention, a series of processing that a coded bit log likelihood ratio is calculated at the decoding step, a constrained metric of the transmission candidates is calculated based on the coded bit log likelihood ratio at the transmission candidate search step, and a bit log likelihood ration is calculated by using the constrained metric at the LLR calculation step may be iterated by a predetermined number of times.

(18) A reception program according to one aspect of the invention causes a computer to execute the reception method described above.

### Effects of the Invention

According to one aspect of the invention, a reception apparatus is able to realize excellent transmission performances with a small amount of calculation in MIMO communication.

### BRIEF DESCRIPTION OF THE DRAWINGS

FIG. 1 is a schematic view illustrating a configuration example of a transmission apparatus a1 according to a first embodiment of the invention.

FIG. 2 is one example of a pilot symbol transmitted by the transmission apparatus a1 according to the first embodiment of the invention.

FIG. 3 is a schematic view illustrating a configuration example of a reception apparatus b1 according to the first embodiment of the invention.

FIG. 4 is one example of QPSK (Quadrature Phase Shift Keying).

FIG. 5 is a flowchart illustrating an operation of the reception apparatus b1 according to the first embodiment of the invention.

FIG. 6 is a schematic view illustrating a configuration example of a reception apparatus b2 according to a second embodiment of the invention.

FIG. 7 is a flowchart illustrating an operation of the reception apparatus b2 according to the second embodiment of the invention.

FIG. 8 is one example of QR decomposition when the number of transmit antennas is larger than the number of receive antennas.

FIG. 9 is a schematic view illustrating a configuration example of a transmission apparatus a3 according to a third embodiment of the invention.

FIG. 10 is one example of a pilot symbol transmitted by the transmission apparatus a3 according to the third embodiment of the invention.

FIG. 11 is a schematic view illustrating a configuration example of a reception apparatus b3 according to the third embodiment of the invention.

FIG. 12 is a flowchart illustrating an operation of the reception apparatus b3 according to the third embodiment of the invention.

FIG. 13 is a schematic view illustrating a configuration example of a reception apparatus b4 according to a fourth embodiment of the invention.

FIG. 14 is a flowchart illustrating an operation of the reception apparatus b4 according to the fourth embodiment of the invention.

FIG. 15 is a schematic view illustrating a configuration example of a reception apparatus b5 according to a fifth embodiment of the invention.

FIG. 16 is a flowchart illustrating an operation of the reception apparatus b5 according to the fifth embodiment of the invention.

FIG. 17 is a schematic view illustrating a configuration example of a reception apparatus b6 according to a sixth embodiment of the invention.

FIG. 18 is a flowchart illustrating an operation of the reception apparatus b6 according to the sixth embodiment of the invention.

FIG. 19 is a schematic view illustrating one example of a MIMO communication system.

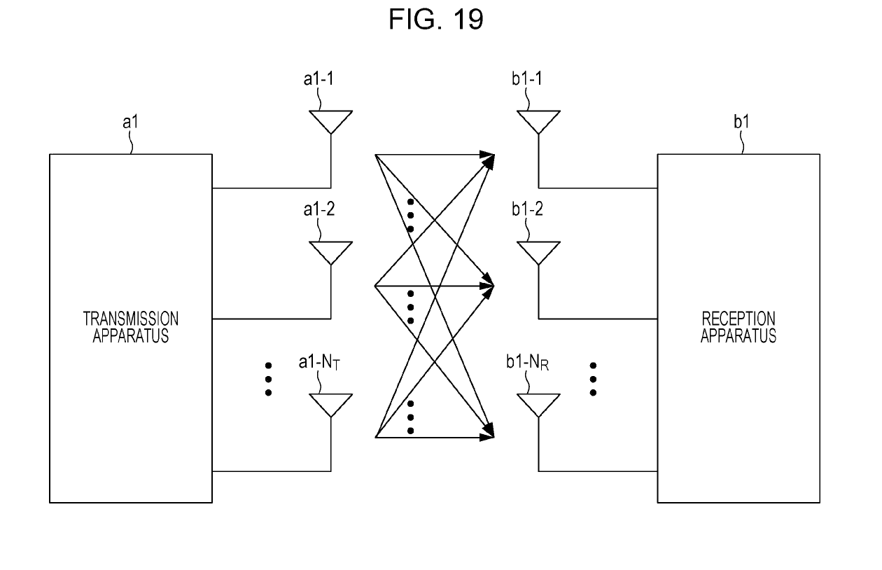

### MODE FOR CARRYING OUT THE INVENTION

Description will hereinafter be given for embodiments of the invention with reference to accompanying drawings.

In the following embodiments, an example in which a transmission apparatus performs data transmission by using an OFDM (Orthogonal Frequency Division Multiplexing) scheme will be described. In the following embodiments, however, other transmission schemes, for example, single carrier transmission schemes such as single carrier transmission, SC-FDMA (Single Carrier-Frequency Division Multiple Access) and DFT-s-OFDM (Discrete Fourier Transform-spread-OFDM) and the like, and multi carrier transmission schemes such as MC-CDMA (Multiple Carrier-Code Division Multiple Access) and the like may be used.

### First Embodiment

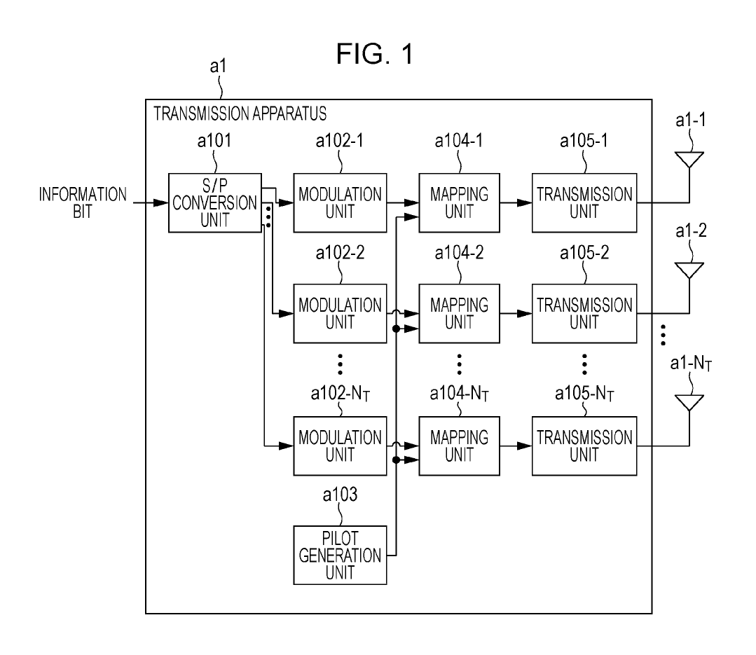

A first embodiment of the invention will be described below. FIG. 1 is a schematic block diagram illustrating a configuration of a transmission apparatus a1. In the figure, the transmission apparatus a1 is composed by including an S/P (Serial/Parallel) conversion unit a101, a modulation unit a102-k, a pilot generation unit a103, a mapping unit a104-k, and a transmission unit a105-k. Here, k=1, . . . , N_{T}. A transmit antenna a1-k is illustrated together in FIG. 1.

The S/P conversion unit a101 performs serial and parallel conversion of an information bit which is input to output to the modulation unit a102-k.

The pilot generation unit a103 generates a pilot symbol (also referred to as a reference signal) for performing channel estimation by a reception apparatus and outputs the pilot symbol to the mapping unit a104-k.

The mapping unit a104-k performs mapping of a modulation symbol which is input from the modulation unit a102-k and the pilot symbol which is input from the pilot generation unit a103, based on predefined mapping information, and generates a transmission signal. The mapping unit a104-k outputs the generated transmission signal to the transmission unit a105-k.

The transmission unit a105-k performs digital/analog conversion of the transmission signal which is input from the mapping unit a104-k, and performs waveform shaping of the converted analog signal. The transmission unit a105-k up-converts the signal subjected to the waveform shaping from a base band to a radio frequency band to transmit to a reception apparatus b1 from the transmit antenna a1-k.

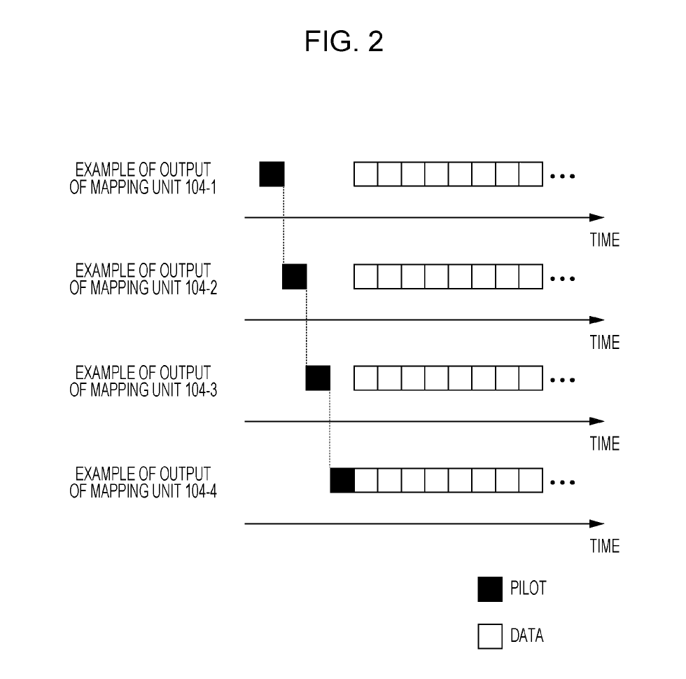

FIG. 2 is an example of outputs of the mapping unit a104-k. In the example, N_{T} is set to 8. In the figure, at a timing when a pilot symbol of a certain stream is transmitted, data of other streams is not transmitted. The reception apparatus b1 is able to perform channel estimation by using a received signal at a time when only a pilot symbol is transmitted.

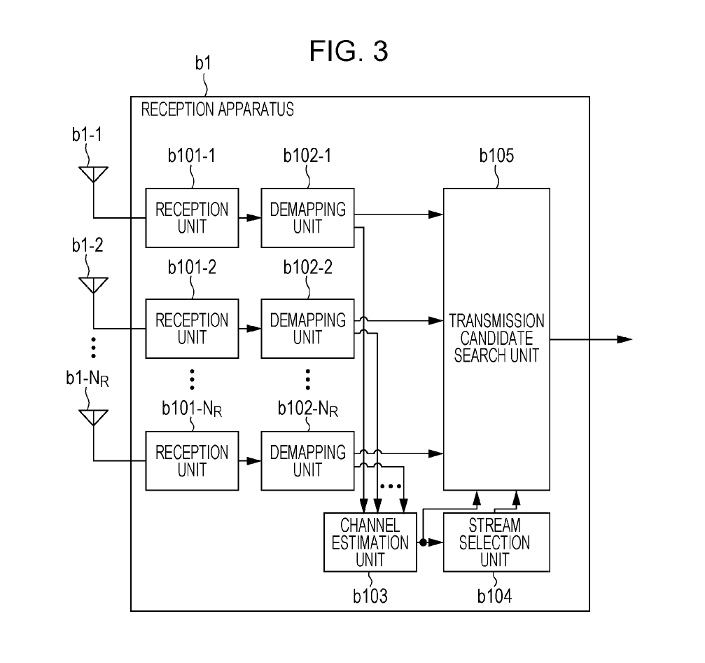

FIG. 3 is a schematic block diagram illustrating a configuration of the reception apparatus b1 according to the present embodiment. In the figure, the reception apparatus b1 is composed by including a reception unit b101-r, a demapping unit b102-r, a channel estimation unit b103, a stream selection unit b104, and a transmission candidate search unit b105. Here, r=1, . . . , N_{R}. A receive antenna b1-r is illustrated together in FIG. 3.

The reception unit b101-r receives the transmission signal, which is transmitted by the transmission apparatus a1, through the receive antenna b1-r. The reception unit b101-r performs frequency transform and analog/digital conversion for the received signal. The reception unit b101-r outputs the received signal, which was transformed and converted, to the demapping unit b102-r.

The demapping unit b102-r demultiplexes a received signal at a timing when a pilot symbol was transmitted and a received signal at a timing when data was transmitted. The demapping unit b102-r outputs, to the channel estimation unit b103, the received signal at the timing when the pilot symbol was transmitted. The demapping unit b102-r outputs, to the transmission candidate search unit b105, the received signal at the timing when the data was transmitted.

The channel estimation unit b103 performs channel estimation by using the received signal at the timing when the pilot symbol was transmitted, which is input from the demapping unit b102-r, and calculates a channel value. The channel estimation unit b103 outputs the calculated channel value to the stream selection unit b104 and the transmission candidate search unit b105.

Based on the channel value input from the channel estimation unit b103, the stream selection unit b104 selects non-linear streams (first stream group) for which non-linear processing is performed and linear streams (second stream group) for which demodulation is performed by calculating a linear detection signal. The stream selection unit b104 outputs information of the linear streams and the non-linear streams, which are selected, to the transmission candidate search unit b105.

Based on the information of the linear streams and the non-linear streams, which are input from the stream selection unit b104, the transmission candidate search unit b105 rearranges streams to be subjected to processing. In the invention, when the number of the non-linear streams is set as N_{K}, streams of 1, . . . , N_{T} input from the demapping unit b102-r are rearranged so that N_{T}−N_{K} pieces of a first half become linear streams and N_{K} pieces of a last half become non-linear streams. Specifically, column vectors of a channel matrix which will be explained in operation principle below are rearranged. Note that, this is one example and there is no limitation to such rearrangement.

The transmission candidate search unit b105 generates non-linear candidates serving as possible transmission candidates of N_{T}−N_{K}+1-th, N_{T}-th rearranged streams, that is, the non-linear streams (candidates of the first stream).

The transmission candidate search unit b105 generates a linear detection signal based on the generated non-linear candidates. Specifically, before starting search of the non-linear candidates, linear detection which is not based on constraint by the non-linear candidates is performed to calculate a non-constrained linear detection signal. Note that, for the linear detection, a conventional linear detection scheme such as ZF (Zero Forcing) or MMSE (Minimum Means Square Error) is usable. By correcting the non-constrained linear detection signal based on the generated non-linear candidates, the linear detection signal is able to be generated. Note that, for generating the linear detection signal, the received signal may be deformed based on the non-linear candidates to perform linear detection for the received signal which has been deformed. A canceller such as an SIC (Successive Interference Canceller) may be used for the linear detection.

The transmission candidate search unit b105 makes hard decision for the linear detection signal, generates transmission candidates of the linear streams, and combines the transmission candidates and corresponding non-linear candidates to thereby generate transmission candidates of all the streams.

The transmission candidate search unit b105 calculates a metric of each of the transmission candidates. The transmission candidate search unit b105 selects a transmission candidate, a metric of which is minimum, and outputs a bit corresponding to the selected transmission candidate.

### <About Operation Principle>

Operation principle of the reception apparatus b1 will be described below with reference to FIG. 3.

An N_{R}-th dimensional received signal vector at a timing when certain data was transmitted (a symbol number is omitted) may be represented as the following formulas (1) to (4).

$$\begin{matrix}[ Expression 1 ] & \\ \begin{matrix}y = {( {y}_{1} … {y}_{{N}_{R}} )}^{T} \\ = Hs + n\end{matrix} & ( 1 ) \\ H = ( {h}_{1} … {h}_{{N}_{T}} ) & ( 2 ) \\ {h}_{k} = {( {h}_{1 k} … {h}_{{N}_{T} k} )}^{T} & ( 3 ) \\ s = {( {s}_{1} … {s}_{{N}_{T}} )}^{T} & ( 4 )\end{matrix}$$

Here, yᵣ is a received signal of an r-th antenna (an output of the demapping unit b102-r), H is a channel matrix with N_{R} rows and N_{T} columns, hₖ is a channel vector of an N_{R}-th dimensional k-th stream, hᵣₖ is a channel value from the k-th stream to the receive antenna b1-r, s is an N_{T}-th dimensional transmission vector, sₖ is a transmission signal of the k-th stream, and n is an N_{R}-th dimensional noise vector. Superscript ^{T} represents transpose of a matrix or a vector.

Description will be given below by assuming that a channel matrix H was able to be estimated by the channel estimation unit b103. Based on the channel matrix H, the stream selection unit b104 selects streams whose performances are deteriorated in linear detection. For example, it is possible to select such streams one by one. Equivalent amplitude which is amplitude after the linear detection is usable for the selection. K is a set in which the selected non-liner streams are saved and K′ is a set in which the linear streams are saved. An initial value of K is [ ] (a set having no element) and an initial value of K′ is [1, 2, . . . , N_{T}]. When the equivalent amplitude for selecting a first non-linear stream is μ_{k,1}, μ_{k,1} may be represented by the following formulas (5) and (6).

[Expression 2]

μ_{k,1}=cₖ^{H}PH^{H}Hcₖ (5)

P=(H^{H}H+σ²I_{N}_{_{T}})⁻¹ (6)

Here, cₖ represents a vector having a size N_{T}, in which a k-th element is 1 and other elements are 0, and σ² represents noise power, and I_{α} (α is a natural number) represents a unit matrix with a rows and a columns. Superscript ^{H} represents complex conjugate transpose of a matrix or a vector. k which is included in K′ and μ_{k,1} of which is small is regarded as a stream whose performances are deteriorated in linear detection and k μ_{k,1} of which is minimum is selected as the first non-linear stream. This k is set as k₁. k₁ is added to K and k₁ is deleted from K′.

Next, for selecting a second non-linear stream, equivalent amplitude μ_{k,2} on the premise that the first stream has been selected is calculated as the following formulas (7) and (8).

$$\begin{matrix}[ Expression 3 ] & \\ {μ}_{k , 2} = {μ}_{k , 1} - \frac{{\vert {g}_{2} ( k , {k}_{1} ) \vert}^{2}}{{g}_{2} ( {k}_{1} , {k}_{1} )} & ( 7 ) \\ {g}_{2} ( k , α ) = {p}_{k α}^{′} & ( 8 )\end{matrix}$$

Here, p′_{kα} is an element in a k-th row and an α-th column of a matrix with N_{T} rows and N_{T} columns, which is represented by the following formula (9).

[Expression 4]

P′=PH^{H}H−I_{N}_{_{T}} (9)

Similarly to the selection of the first non-linear stream, k which is an element of K′ and μ_{k,2} of which is minimum is selected as the second non-linear stream. This k is set as k₂. k₂ is added to K and k₂ is deleted from K′.

Subsequently, for selecting a β-th (β>2) non-linear stream, equivalent amplitude μ_{k,β} when stream selection of the β−1-th time is performed is calculated as the following formulas (10) and (11).

$$\begin{matrix}[ Expression 5 ] & \\ {μ}_{k , β} = {μ}_{k , β - 1} - \frac{{\vert {g}_{β} ( k , {k}_{β - 1} ) \vert}^{2}}{{g}_{β} ( {k}_{β - 1} , {k}_{β - 1} )} & ( 10 ) \\ {g}_{β} ( k , α ) = {g}_{β - 1} ( k , α ) - \frac{{g}_{β - 1} ( k , {k}_{β - 2} ) {g}^{*} β - 1 ( α , {k}_{β - 2} )}{{g}_{β - 1} ( {k}_{β - 2} , {k}_{β - 2} )} & ( 11 )\end{matrix}$$

Note that, the formulas (5), (7) and (10) are mathematically equal to the following formula (12).

$$\begin{matrix}[ Expression 6 ] & \\ {μ}_{k , β} = {{h}_{k}^{H} ( {\sum }_{v ∈ {K}_{β - 1}^{′}} {h}_{v} {h}_{v}^{H} + {σ}_{n}^{2} {I}_{{N}_{R}} )}^{- 1} {h}_{k} & ( 12 )\end{matrix}$$

Here, K′_{β} is K′ which is determined up to β-th iteration. k which is an element of K′ and μ_{k,β} of which is minimum is selected as a β-th non-linear stream. This k is set as k_{β}. k_{β} is added to K and k_{β} is deleted from K′.

Finally, a number of the non-linear stream is saved in K and a number of the linear stream is saved in K′. Note that, the number of the non-linear streams N_{K} may be fixed at a stage where the reception apparatus b1 is designed or may be changed when firmware or software of the reception apparatus b1 is updated. Further, a value of N_{K} may be determined by the reception apparatus b1 adaptively. For example, when μ_{k,β} which is below a certain threshold becomes absent, the selection of the non-linear streams may end at that time. The threshold may be calculated from an error rate of a modulation scheme in use.

Next, rearrangement of streams is performed based on information of the linear streams and the non-linear streams, which are selected. First, considered is a rearranged matrix C_{K} of non-linear streams of N_{T} rows and N_{K} columns. A k-th column vector of C_{K} is a vector in which only an element indicated by a k-th element of K is 1 and other elements are 0. Similarly, considered is a rearranged matrix C_{K′} of linear streams of N_{T} rows and (N_{T}−N_{K}) columns. A k-th column vector of C_{K′} is a vector in which only an element indicated by a k-th element of K′ is 1 and other elements are 0. For example, when K={1,2,4} and K′={3,5,6,7,8} in a case of N_{T}=8, C_{K} and C_{K′} are represented by the following formulas (13) and (14).

$$\begin{matrix}[ Expression 7 ] & \\ {C}_{K} = ( \begin{matrix}1 & 0 & 0 \\ 0 & 1 & 0 \\ 0 & 0 & 0 \\ 0 & 0 & 1 \\ 0 & 0 & 0 \\ 0 & 0 & 0 \\ 0 & 0 & 0 \\ 0 & 0 & 0\end{matrix} ) & ( 13 ) \\ {C}_{{K}^{′}} = ( \begin{matrix}0 & 0 & 0 & 0 & 0 \\ 0 & 0 & 0 & 0 & 0 \\ 1 & 0 & 0 & 0 & 0 \\ 0 & 0 & 0 & 0 & 0 \\ 0 & 1 & 0 & 0 & 0 \\ 0 & 0 & 1 & 0 & 0 \\ 0 & 0 & 0 & 1 & 0 \\ 0 & 0 & 0 & 0 & 1\end{matrix} ) & ( 14 )\end{matrix}$$

Next, searching processing of the transmission candidate search unit b105 will be described. First, by using linear detection with MMSE reference, the transmission candidate search unit b105 is able to calculate an N_{T}-th dimensional vector x which is a non-constrained linear detection signal as the following formulas (15) and (16).

$$\begin{matrix}[ Expression 8 ] & \\ x = Wy & ( 15 ) \\ W = ( \begin{matrix}{C}_{{K}^{′}}^{H} \\ {C}_{K}^{H}\end{matrix} ) {PH}^{H} & ( 16 )\end{matrix}$$

Note that, since the formula (16) has many commonalties with the formula (5), a result when calculation of the formula (5) is performed is usable for calculation of the formula (16).

The transmission candidate search unit b105 generates an N_{K}-th dimensional non-linear candidate vector b_{K,m}, and calculates an N_{T}−N_{K}-th dimensional vector z_{K′,m} which represents a linear detection signal as the following formulas (17) to (19).

$$\begin{matrix}[ Expression 9 ] & \\ {z}_{{K}^{′} , m} = {x}_{{K}^{′}} + {U}_{K} ( {b}_{m} - {x}_{K} ) & ( 17 ) \\ {U}_{K} = {C}_{{K}^{′}}^{H} {{PC}_{K} ( {C}_{K}^{H} {PC}_{K} )}^{- 1} & ( 18 ) \\ {b}_{K , m} = [ \begin{matrix}{b}_{{N}_{T} - {N}_{K} + 1} ( {m}_{{N}_{T} - {N}_{K} + 1} ) \\ ⋮ \\ {b}_{{N}_{T}} ( {m}_{{N}_{T}} )\end{matrix} ] & ( 19 )\end{matrix}$$

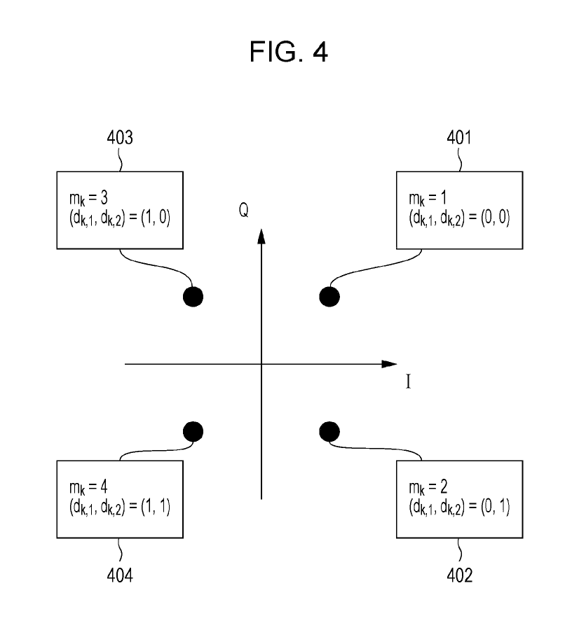

Here, x_{K′} is a vector composed of first, . . . , N_{T}−N_{K}-th elements of x, x_{K} is a vector composed of N_{T}−N_{K}+1-th, . . . , N_{T}-th elements of x, and U_{K} is a correction weight matrix of linear detection of N_{T}−N_{K} rows and N_{K} columns. In addition, bₖ(mₖ) is one of modulation points of a k-th rearranged stream, and mₖ is a number specifying the modulation point. For example, when the k-th rearranged stream uses QPSK, mₖ and the modulation point may have a relation like in FIG. 4. Note that, d_{k,q} of FIG. 4 represents a q-th bit of the k-th rearranged stream and relations thereof are represented by the following formulas (20) and (21).

$$\begin{matrix}[ Expression 10 ] & \\ {m}_{k} = 2 {d}_{k , 1} + {d}_{k , 2} + 1 & ( 20 ) \\ {b}_{k} ( {m}_{k} ) = \frac{1 - {d}_{k , 1}}{\sqrt{2}} + j \frac{1 - {d}_{k , 2}}{\sqrt{2}} & ( 21 )\end{matrix}$$

Here, j is an imaginary unit. Moreover, when the k-th rearranged stream uses 16QAM, the relations may be represented by the following formulas (22) and (23).

$$[ Expression 11 ]$$

$$\begin{matrix}{m}_{k} = 8 {d}_{k , 1} + 4 {d}_{k , 2} + 2 {d}_{k , 3} + {d}_{k , 4} + 1 & ( 22 ) \\ {b}_{k} ( {m}_{k} ) = \frac{2 {d}_{k , 3} + 1}{\sqrt{10}} ( 1 - 2 {d}_{k , 1} ) + j \frac{1 - {d}_{k , 2}}{\sqrt{10}} ( 1 - 2 {d}_{k , 2} ) & ( 23 )\end{matrix}$$

In addition, m of the formula (19) is a number representing a combination of mₖ when k=N_{T}−N_{K}+1, . . . , N_{T}, and may be represented by the following formula (24).

$$[ Expression 12 ]$$

$$m = 1 + {\sum }_{k = {N}_{T} - {N}_{K} + 1}^{{N}_{T}} {\prod }_{v = k + 1}^{{N}_{T}} {M}_{v} ( {m}_{k} - 1 ) . \qquad ( 24 )$$

Here, Mₖ is the number of the modulation points of the k-th rearranged stream. Note that, FIG. 4 and the formulas (20) to (24) are one example and other configuration may be used.

The transmission candidate search unit b105 makes hard decision for a linear detection signal vector z_{K′,m}, and calculates a transmission candidate vector of an N_{T}−N_{K}-th dimensional linear stream. Specifically, it may be represented by the following formula (25).

[Expression 13]

b_{K′,m}=Dec[z_{K′,m}] (25)

Here, Dec[ ] represents hard-decision processing. The transmission candidate search unit b105 couples b_{K′,m} and b_{K,m} and generates an N_{T}-th dimensional transmission candidate vector bₘ. bₘ may be represented by the following formula (26).

$$[ Expression 14 ]$$

$${b}_{m} = ( \begin{matrix}{b}_{{K}^{′} , m} \\ {b}_{K , m}\end{matrix} ) \qquad ( 26 )$$

As in the formula (24), m=1, . . . , ΠₖMₖ, but hard decision of x may be added as the transmission candidate when m=0. In this case, the formula (26) is defined also in the case of m=0, and the following formula (27) is added.

[Expression 15]

b₀=Dec[x] (27)

The transmission candidate search unit b105 calculates a metric of bₘ as the following formula (28).

[Expression 16]

∥y−H(C_{K′}C_{K})bₘ∥² (28)

The transmission candidate search unit b105 selects bₘ a metric of which is minimum and outputs a corresponding bit sequence.

<About Operation of Reception Apparatus b1>

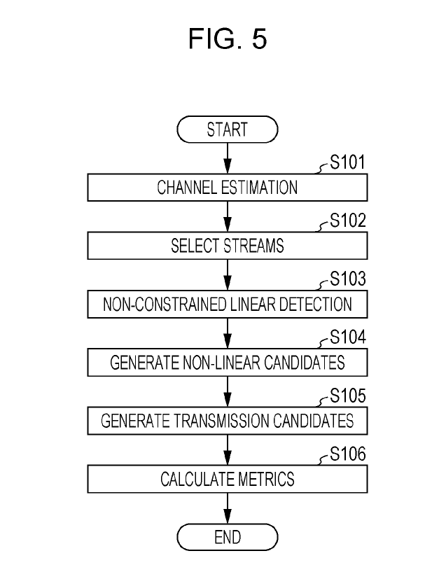

FIG. 5 is a flowchart illustrating an operation of the reception apparatus according to the present embodiment. Note that, the operation illustrated by the figure is processing after the demapping unit b102-r of FIG. 3 demultiplexed a received signal at a timing when data was transmitted and a received signal at a timing when a pilot symbol was transmitted.

(Step S101) The channel estimation unit b103 performs channel estimation based on the received signal at the timing when the pilot symbol was transmitted. Then, the procedure moves to step S102.

(Step S102) The stream selection unit b104 selects linear streams and non-linear streams based on a channel value obtained at step S101. Then, the procedure moves to step S103.

(Step S103) The transmission candidate search unit b105 performs non-constrained linear detection based on the channel value obtained at step S101. Then, the procedure moves to step S104.

(Step S104) The transmission candidate search unit b105 generates non-linear candidates. Then, the procedure moves to step S105.

(Step S105) The transmission candidate search unit b105 corrects a non-constrained linear detection signal, which is obtained at step S103, based on the non-linear candidates obtained at step S104, and generates a linear detection signal. The transmission candidate search unit b105 generates transmission candidates based on the linear detection signal. Then, the procedure moves to step S106.

(Step S106) The transmission candidate search unit b105 calculates metrics of the transmission candidates obtained at step S105. The transmission candidate search unit b105 outputs a bit sequence corresponding to a transmission candidate a metric of which is minimum. The reception apparatus b1 then ends the operation.

In this manner, according to the present embodiment, the linear streams and the non-linear streams are selected, non-linear detection is performed only for the non-linear streams, and the linear detection signal is calculated based on the non-linear candidates. This makes it possible to realize excellent transmission performances with a small amount of calculation.

Note that, though description has been given for a case where all possible non-linear candidates b_{K′,m} are generated in the first embodiment, which may not be the all.

Note that, processing may be expanded so as to reduce interference in the first embodiment. For example, a received signal in the case of including other cell interference may be represented as the following formula (29).

$$[ Expression 17 ]$$

$$\\ y = Hs + {\sum }_{l} {H}_{l}^{( I )} {s}_{l}^{( I )} + n \qquad ( 29 )$$

Here, Hₗ^{(I)} represents a channel matrix of an l-th cell, and sₗ^{(I)} represents a transmission signal vector of the l-th cell. In such a case, a correlation matrix P like the following formula (30) is considered.

$$[ Expression 18 ]$$

$$P = {\sum }_{i} {H}_{l}^{( I )} {H}_{l}^{( I ) H} + {σ}_{n}^{2} \qquad ( 30 )$$

When the transmission candidate search unit b105 multiplies y by P^{1/2} and the channel estimation unit b103 multiplies the estimated channel matrix H by P^{1/2} before the processing described in the first embodiment is performed, interference may be reduced. Here, P^{1/2} may be a triangular matrix obtained by performing Cholesky decomposition of P, or may be a matrix obtained by performing eigenvalue decomposition of P and calculating a square root of an eigenvalue. Moreover, P may be notified from the transmission apparatus a1, or may be estimated by the reception apparatus b1 from a pilot symbol which is transmitted by a transmission apparatus of another cell. The similar is applied also to embodiments below.

Note that, though description has been given for a case where the stream selection unit b104 selects linear streams and non-linear streams based on a channel value in the first embodiment, a modulation scheme used by each stream may be considered. For example, when QPSK and 16QAM are mixed, by selecting the non-linear streams from streams of QPSK, a calculation amount may be reduced. For example, when QPSK and 16QAM are mixed, by selecting the non-linear streams from streams of 16QAM, transmission performances may be improved. The similar is applied also to the embodiments below.

Note that, though description has been given for a case where the stream selection unit b104 selects linear streams and non-linear streams based on equivalent amplitude obtained from a channel value in the first embodiment, streams having large diagonal components of P may be set as the non-linear streams. This means that streams having large diagonal components of an inverse matrix of a correlation matrix of a received signal are selected as the non-linear streams.

Note that, though description has been given for a case where N_{T} streams are multiplexed in the first embodiment, the number thereof may be small. It may be set that the number of transmit antennas is N_{T} and the number of streams to be multiplexed may be N_{U}. That is, only k=1, . . . , N_{U} may be used among the modulation unit a102-k and the mapping unit a104-k of FIG. 1. In this case, the channel matrix of the formula (2) is merely to have N_{R} rows and N_{U} columns, and the method described above may be used as it is. The similar is applied also to the embodiments below.

### Second Embodiment

A second embodiment of the invention will be described below in detail with reference to drawings. The reception apparatus b1 selects a transmission candidate a metric of which is minimum in the first embodiment. A method for reducing an amount of calculation for searching for a transmission candidate by using QR decomposition will be described in the present embodiment.

Note that, since a transmission apparatus according to the second embodiment of the invention has the same configuration as that of the transmission apparatus a1 according to the first embodiment, description thereof will be omitted.

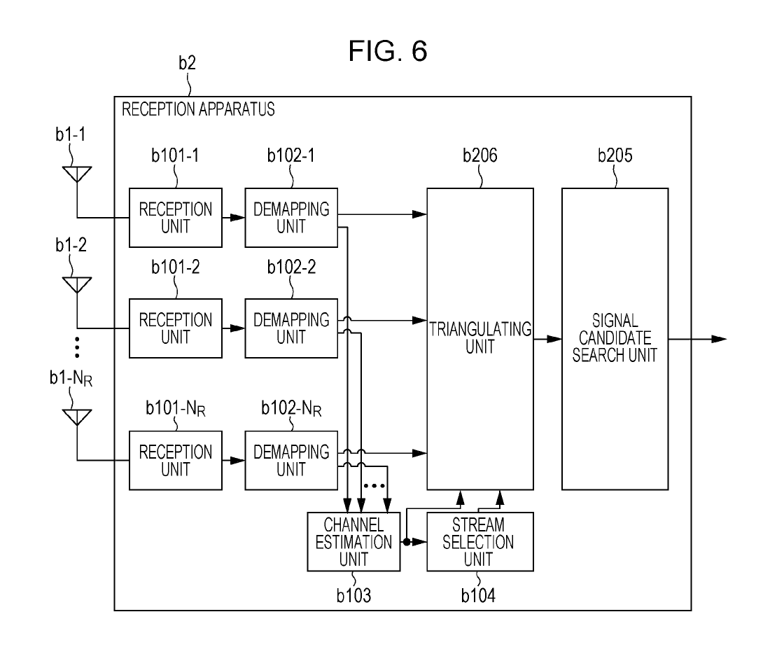

FIG. 6 is a schematic block diagram illustrating a configuration of a reception apparatus b2 according to the second embodiment of the invention. When comparing the reception apparatus b2 (FIG. 6) according to the present embodiment to the reception apparatus b1 (FIG. 3) according to the first embodiment, a signal candidate search unit b205 is different and a triangulating unit b206 is added. However, functions that other components (the reception unit b101-r, the demapping unit b102-r, the channel estimation unit b103 and the stream selection unit b104) have are the same as those of the first embodiment. Description for the functions same as those of the first embodiment will be omitted.

The triangulating unit b206 performs QR decomposition for a channel value input from the channel estimation unit b103, based on information of linear streams and non-linear streams, which is input from the stream selection unit b104. The triangulating unit b206 uses a submatrix of a unitary matrix obtained as a result of the QR decomposition to perform orthogonal conversion of a received signal. This corresponds to an operation of triangulating a channel. The triangulating unit b206 outputs a triangulated received signal obtained by performing orthogonal conversion of the received signal to the signal candidate search unit b205.

The transmission candidate search unit b205 performs normal linear detection and generates a non-constrained linear detection signal. The transmission candidate search unit b205 calculates a metric of the non-constrained linear detection signal based on a hard-decision value for the non-constrained linear detection signal and the triangulated received signal which is input from the triangulating unit b206. The transmission candidate search unit b205 saves the metric as a reference metric and saves the hard-decision value for the non-constrained linear detection signal.

The transmission candidate search unit b205 generates non-linear candidates serving as possible transmission candidates of N_{T}−N_{K}+1-th, N_{T}-th rearranged streams that is, non-linear streams, which are non-linear candidates in which a cumulative metric of each rearrangement is below the reference metric. The transmission candidate search unit b205 corrects the non-constrained linear detection signal based on the generated non-linear candidates to thereby generate a linear detection signal.

The transmission candidate search unit b205 makes hard decision for the linear detection signal, generates transmission candidates of the linear streams, and combines the transmission candidates and corresponding non-linear candidates to thereby generate transmission candidates of all the streams. The transmission candidate search unit b205 calculates a metric of the transmission candidates. When the generated metric is below the reference metric, the transmission candidate search unit b205 saves the generated metric as a new reference metric, and saves a bit sequence of the corresponding transmission candidate.

The transmission candidate search unit b205 performs the selection of the non-linear candidates, the generation of the linear detection signal and the updating of the metric, which are described above, until a non-linear candidate which is able to be selected does not exist.

### <About Operation Principle>

Operation principle of the reception apparatus b2 will be described below with reference to FIG. 6. The description for the formulas (1) to (12) of the first embodiment is able to be applied similarly also to the present embodiment.

The triangulating unit b206 performs QR decomposition after rearranging a channel matrix of the formula (2) based on linear streams K and non-linear streams K′, which are selected. Here, rearrangement may be further performed in K. For example, it is possible to calculate power values indicated by the following formula (31) in streams included in K for rearrangement in an ascending order.

[Expression 19]

∥hₖ∥² (31)

For example, when K={1,2,4}, power values of h₁, h₂, and h₄ are calculated based on the formula (31) above and rearranged in an ascending order. This makes it possible to make search of non-liner candidates described below more efficient. Note that, the rearrangement may not be based on power. Moreover, similar rearrangement may be performed also for K′.

For example, in a case of N_{T}=8, K={1,2,4} and K′{3,5,6,7,8}, and when K={2,4,1} and K′={5,8,6,3,7} as a result of the rearrangement described above, the rearranged matrixes C_{K} and C_{K′}, which are described in the first embodiment, are deformed as the following formulas (32) and (33).

$$\begin{matrix}[ Expression 20 ] \\ {C}_{K} = ( \begin{matrix}0 & 0 & 1 \\ 1 & 0 & 0 \\ 0 & 0 & 0 \\ 0 & 1 & 0 \\ 0 & 0 & 0 \\ 0 & 0 & 0 \\ 0 & 0 & 0 \\ 0 & 0 & 0\end{matrix} ) & ( 32 ) \\ {C}_{{K}^{′}} = ( \begin{matrix}0 & 0 & 0 & 0 & 0 \\ 0 & 0 & 0 & 0 & 0 \\ 0 & 0 & 0 & 1 & 0 \\ 0 & 0 & 0 & 0 & 0 \\ 1 & 0 & 0 & 0 & 0 \\ 0 & 0 & 1 & 0 & 0 \\ 0 & 0 & 0 & 0 & 1 \\ 0 & 1 & 0 & 0 & 0\end{matrix} ) & ( 33 )\end{matrix}$$

The channel matrix H is rearranged in a column direction by using such rearranged matrixes, and QR decomposition like the following formula (34) is performed for the rearranged matrix.

[Expression 21]

(HC_{K′}HC_{K})=QR (34)

Here, Q is a submatrix of a unitary matrix with N_{R} rows and N_{T} columns, and R is an upper triangular matrix with N_{T} rows and N_{T} columns. Note that, in the case of N_{T}, K and K′ described above, (HC_{K′} HC_{K}) represents (h₅ h₈ h₆ h₃ h₇ h₂ h₄ h₁). The triangulating unit b206 calculates an N_{T}-th dimensional triangulated received signal vector y′ as the following formula (35).

[Expression 22]

y′=Q^{H}y (35)

The transmission candidate search unit b205 calculates a non-constrained linear detection signal x by using the formulas (15) and (16) of the first embodiment, and calculates a metric f_{MMSE} as the following formula (36).

[Expression 23]

f_{MMSE}=∥y′−RDec[x]∥² (36)

The transmission candidate search unit b205 saves the metric f_{MMSE}, which is calculated in this manner, as a reference metric.

The transmission candidate search unit b205 selects a non-linear candidate. Specifically, the non-linear candidate is selected so that a metric thereof does not exceed a reference metric. A k-th (k=N_{T}−N_{K}+1, . . . , N_{T}) cumulative metric is represented by the following formula (37).

$$[ Expression 24 ]$$

$${f}_{k} = \{ \begin{matrix}{f}_{k + 1} + {\vert {y}_{k}^{′} - {\sum }_{v = k}^{{N}_{T}} {r}_{kv} {b}_{v} ( {m}_{v} ) \vert}^{2} & ( k < {N}_{T} ) \\ {\vert {y}_{k}^{′} - {r}_{kk} {b}_{k} ( {m}_{k} ) \vert}^{2} & ( k = {N}_{T} )\end{matrix} \qquad ( 37 )$$

Here, y′ₖ is a k-th element of y′, and rₖᵥ is an element in a k-th row and a v-th column of R. By selecting bₖ(mₖ) that fₖ does not exceed the reference metric in order of k=N_{T}, . . . , N_{T}−N_{K}+1, the non-linear candidate vector b_{k,m} indicated in the formula (19) of the first embodiment is selected. Further, by using b_{k,m} and the formulas (17) and (18), the linear detection signal vector z_{K′,m} is calculated. By using Z_{K′,m} and the formulas (25) and (26), the transmission candidate vector b_{K′,m} of linear streams and the transmission candidate vector bₘ of all the streams are calculated. By using b_{K′,m} and the formula (37), a metric fₗ is calculated. Here, fₖ is a cumulative metric, and fₗ is also a metric.

When calculated fₗ is below the reference metric, the transmission candidate search unit b205 saves fₗ as a new reference metric. Moreover, the transmission candidate search unit b205 saves mₖ which is a bit sequence (k=1, . . . , N_{T}). The selection of the non-linear candidates, the generation of the transmission candidates and the updating of the metric, which are described above, are repeated until a non-linear candidate which is able to be selected does not exist.

<About Operation of Reception Apparatus b2>

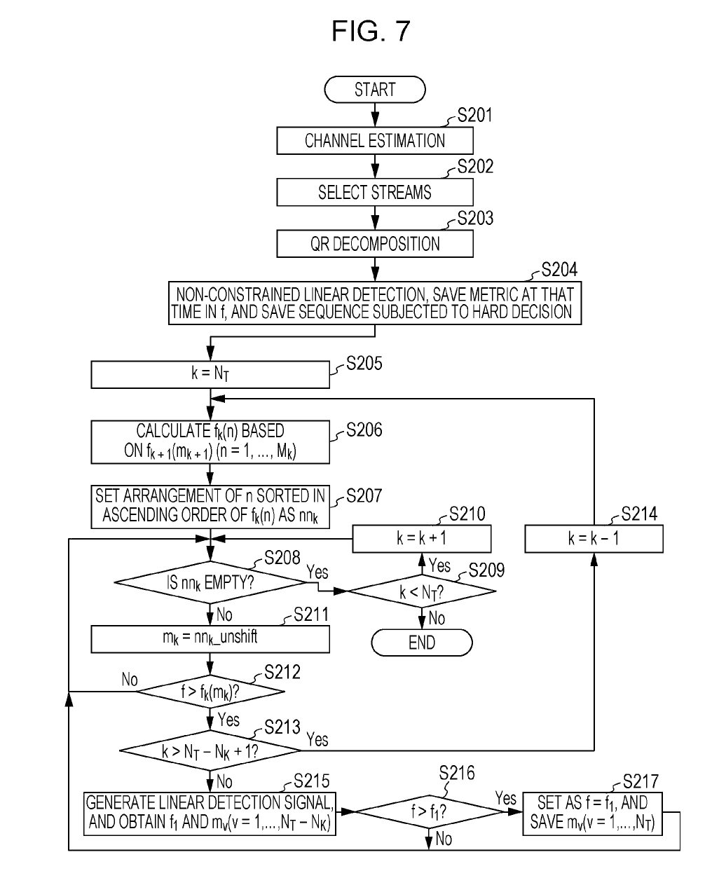

FIG. 7 is a flowchart illustrating an operation of the reception apparatus according to the present embodiment. Note that, the operation illustrated by the figure is processing after the demapping unit b102-r of FIG. 6 demultiplexed a received signal at a timing when data was transmitted and a received signal at a timing when a pilot symbol was transmitted. Note that, as variables for description, f saving a reference metric, k indicating a number of a stream being processed, fₖ(n) saving Mₖ sets of fₖ, and nnₖ saving arrangement in which numbers 1 . . . Mₖ are sorted are used.

(Step S201) The channel estimation unit b103 performs channel estimation based on the received signal at the timing when the pilot symbol was transmitted. Then, the procedure moves to step S202.

(Step S102) The stream selection unit b104 selects linear streams and non-linear streams based on a channel value obtained at step S201. Then, the procedure moves to step S203.

(Step S203) The triangulating unit b206 rearranges the channel matrix H in a column direction based on the linear streams and the non-linear streams obtained at step S202. At this time, rearrangement may be further performed among the linear streams and the non-linear streams. The triangulating unit b206 performs QR decomposition for the rearranged H. The triangulating unit b206 triangulates a received signal based on a result of the QR decomposition. Then, the procedure moves to step S204.

(Step S204) The transmission candidate search unit b205 performs non-constrained liner detection. A sequence obtained as a result thereof is subjected to hard decision and a metric at that time is calculated. The metric is saved in f as a reference metric. Further, a bit sequence thereof is saved. Then, the procedure moves to step S205.

(Step S205) It is set that k=N_{T}. Moreover, each variable is initialized. Then, the procedure moves to step S206.

(Step S206) The cumulative metric represented by the formula (37) is calculated for all modulation symbols being used in the k-th rearranged stream. Specifically, calculation with the following formula (38) is able to be performed for n=1, . . . , Mₖ.

$$[ Expression 25 ]$$

$${f}_{k} ( n ) = \{ \begin{matrix}{f}_{k + 1} ( {m}_{k + 1} ) + {\vert {y}_{k}^{′} - {r}_{kk} {b}_{k} ( n ) - {\sum }_{v = k + 1}^{{N}_{T}} {r}_{kv} {b}_{v} ( {m}_{v} ) \vert}^{2} & ( k < {N}_{T} ) \\ {\vert {y}_{k}^{′} - {r}_{kk} {b}_{k} ( n ) \vert}^{2} & ( k = {N}_{T} )\end{matrix} \qquad ( 38 )$$

Then, the procedure moves to step S207.

(Step S207) n is extracted in an ascending order of fₖ(n) and saved in nnₖ. For example, when fₖ(1)=0.12, fₖ(2)=0.23, fₖ(3)=0.05, and fₖ(4)=0.19 in a case of Mₖ=4, nnₖ=[3,1,4,2]. Then, the procedure moves to step S208. Note that, the sort may not be performed, and in such a case, nnₖ=[1,2,3,4]. The sort may not be performed similarly also in the embodiments below.

(Step S208) When nnₖ is empty, the procedure moves to step S209. When not, the procedure moves to step S211.

(Step S209) When k is smaller than N_{T}, the procedure moves to step S210. When not, the reception apparatus b2 ends processing.

(Step S210) The procedure moves to step S208 after setting as k=k+1.

(Step S211) A value at the beginning of nnₖ is saved in mₖ. The value at the beginning is removed from nnₖ. This processing is called unshift. Then, the procedure moves to step S212.

(Step S212) When f is larger than fₖ(mₖ), the procedure moves to step S213. When not, the procedure moves to step S208.

(Step S213) When k is larger than N_{T}−N_{K}+1, the procedure moves to step S214. When not, the procedure moves to step S215.

(Step S214) The procedure moves to step S206 after setting as k=k−1.

(Step S215) By using mᵥ of v=N_{T}−N_{K}+1, . . . , N_{T}, which has been obtained, a linear detection signal is generated based on the formula (17). By hard decision for the linear detection signal, mᵥ of v=1, . . . , N_{T}, which has not been obtained, is obtained and a metric fₗ at that time is calculated. Then, the procedure moves to step S216.

(Step S216) When f is larger than fₗ, the procedure moves to step S217. When not, the procedure moves to step S208.

(Step S217) f is updated with fₗ. As a new sequence, mᵥ(v=1, . . . , N_{T}) is saved. Then, the procedure moves to step S208.

In this manner, according to the present embodiment, by triangulating a channel matrix by using QR decomposition, an amount of calculation is able to be reduced significantly.

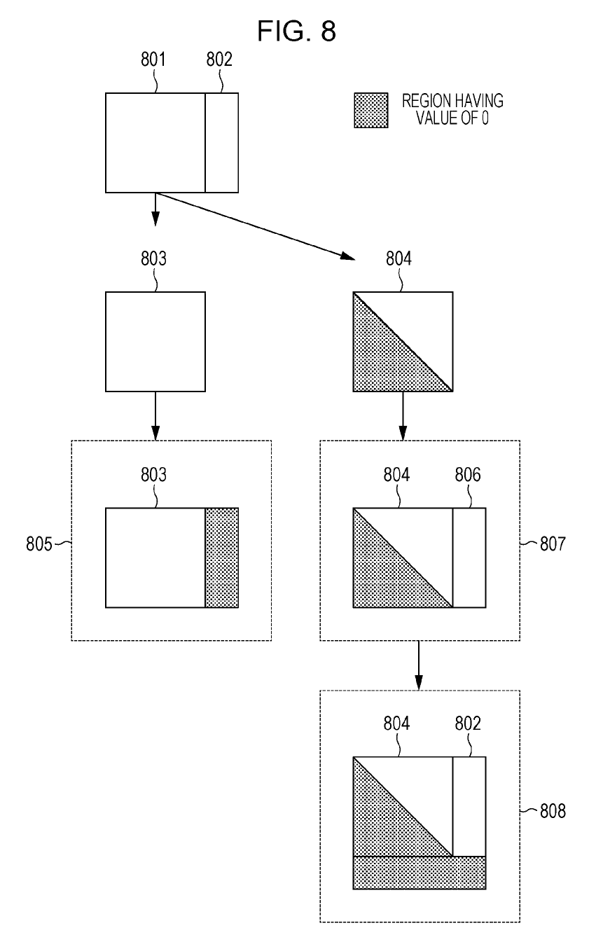

Note that, though description has been given by setting that N_{R} is equal to or more than N_{T} in the second embodiment described above, N_{T} may be larger than N_{R}. FIG. 8 is one example in such a case. 801 denotes a matrix with N_{R} rows and N_{R} columns, which is obtained by extracting first to N_{R}-th columns of (HC_{K′} HC_{K}). 802 denotes a matrix with N_{R} rows and (N_{T}−N_{R}) columns, which is obtained by extracting N_{R}+1-th to N_{T}-th columns of (HC_{K′} HC_{K}). QR decomposition is performed for 801. 803 denotes a unitary matrix with N_{R} rows and N_{R} columns obtained as a result of the QR decomposition. 804 denotes an upper triangular matrix with N_{R} rows and N_{R} columns obtained as a result of the QR decomposition. Note that, a hatched region represents a region having a value of 0. 805 denotes a matrix with N_{R} rows and N_{T} columns, which is obtained by coupling a zero matrix with N_{R} rows and (N_{T}−N_{R}) columns with a right side of 803. 805 may be set as Q. 806 denotes a matrix with N_{T} rows and (N_{T}−N_{R}) columns, which is generated by multiplying complex conjugate transpose of the unitary matrix 803 by the matrix 802. 807 denotes a matrix with N_{R} rows and N_{T} columns, which is obtained by coupling 806 with a right side of 804. 808 denotes a matrix with N_{T} rows and N_{T} columns, which is obtained by coupling a zero matrix with (N_{T}−N_{R}) rows and N_{T} columns with a lower side of 806. 808 may be set as R. This makes it possible to use a method described in the second embodiment as it is. The similar is applied also to the embodiments below.

Note that, though description has been given for a case where non-linear candidates, a cumulative metric of which is below a reference metric, are selected in the second embodiment, the number of non-linear candidates to be output may be limited. For example, when N_{K}=3 and the modulation scheme of non-linear streams is QPSK, sixty-four sets of non-linear candidates are considered, but, for example, by setting that thirty-two or more candidates are not to be selected, it is possible to reduce a calculation amount. The similar is applied also to the embodiments below.

Note that, though description has been given for a case where all linear detection signals of linear streams are generated based on the selected non-linear candidates in the second embodiment, aborting of processing may be performed by sing a cumulative metric also in the linear streams. The similar is applied also to the embodiments below.

### Third Embodiment

A third embodiment of the invention will be described below in detail with reference to drawings. In the first embodiment, the reception apparatus b1 outputs a bit sequence generated by performing hard decision by using non-linear candidates and a linear detection signal. In the present embodiment, described is a method that coding is performed by a transmission apparatus and a bit LLR (Log Likelihood Ratio) is calculated by using non-linear candidates and a linear detection signal to perform decoding by using the calculated LLR in a reception apparatus.

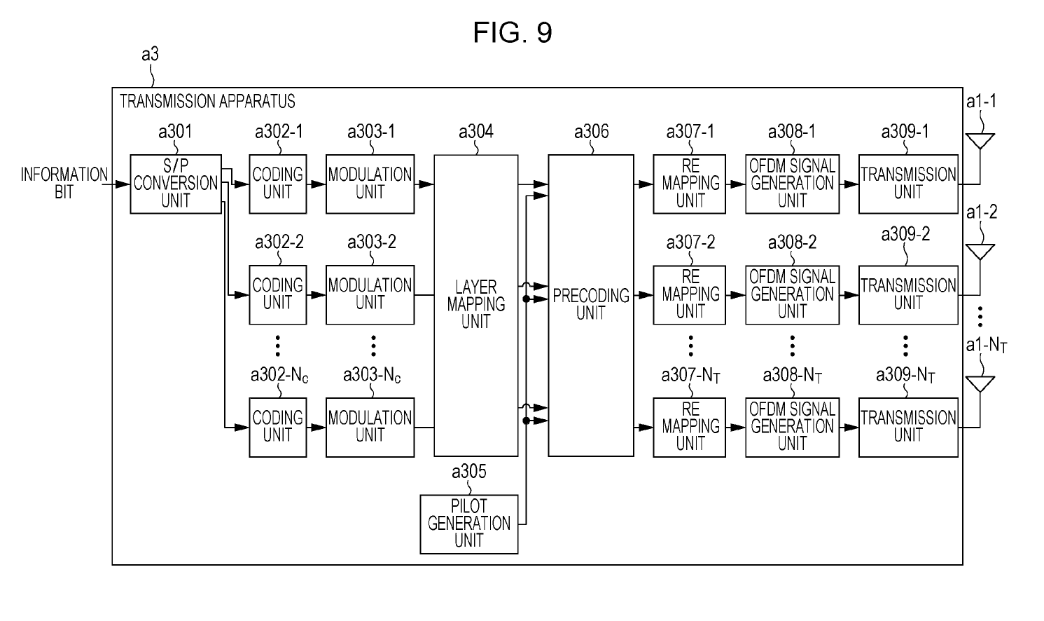

FIG. 9 is a schematic block diagram illustrating a configuration of a transmission apparatus a3 according to the third embodiment of the invention. In the figure, the transmission apparatus a3 is composed by including an S/P conversion unit a301, a coding unit a302-l, a modulation unit a303-l, a layer mapping unit a304, a pilot generation unit b305, a precoding unit a306, an RE (Resource Element) mapping unit a307-k, an OFDM (Orthogonal Frequency Division Multiplexing) signal generation unit a308-k, and a transmission unit a309-k. Here, l=1, . . . , N_{C}, and k=1, . . . , N_{T}. Moreover, N_{C} is the number of code words and represents the number of pieces for coding. The resource element represents one subcarrier in one OFDM symbol, and is a physical resource in which a modulation symbol or a pilot symbol is arranged. Further, a transmit antenna a1-k is illustrated together in FIG. 9.

The S/P conversion unit a301 performs serial and parallel conversion of an information bit, which is input, to output to the coding unit a302-l.

The coding unit a302-l performs coding of a bit which is input from the S/P conversion unit a301 by using an error correction code such as a convolutional code, a turbo code, an LDPC (Low Density Parity Check) code, and generates a coded bit. The coding unit a302-l outputs the coded bit to the modulation unit a303-l.

The modulation unit a303-l modulates the coded bit, which is input from the coding unit a302-l, by using a modulation scheme such as PSK or QAM, to thereby generate a modulation symbol. The modulation unit a303-l outputs the generated modulation symbol to the layer mapping unit a304.

The layer mapping unit a304 allocates the modulation symbol which is input from the modulation unit a303-l to any of streams of 1, . . . , N_{T}, to output to the precoding unit a306.

The pilot generation unit a305 generates a pilot symbol for performing channel estimation by a reception apparatus, and outputs the pilot symbol to the precoding unit a306.

The precoding unit a306 performs precoding for the modulation symbol which is input from the layer mapping unit a304 and the pilot symbol which is input from the pilot generation unit a305. Specifically, it is possible to multiply a unitary matrix based on a code book or a submatrix of the unitary matrix. In addition, an STBC (Space Time Block Code), an SFBC (Space Frequency Block Code) or the like may be used.

The RE mapping unit a307-k performs mapping of the modulation symbol and the pilot symbol subjected to precoding, which are input from the precoding unit a306, into a resource element. The RE mapping unit a307-k outputs a symbol of the resource element subjected to mapping to the OFDM signal generation unit a308-k.

The OFDM signal generation unit a308-k performs frequency-time transform for the symbol which is input from the RE mapping unit a307-k, and generates a signal of a time domain. Specifically, IFFT (Inverse Fast Fourier Transform) is usable for the frequency-time transform. The OFDM signal generation unit a308-k applies load of CP (Cyclic Prefix) to the generated signal of the time domain, and generates an OFDM signal. Here, the CP is a part of a rear of the signal of the time domain obtained by the frequency-time transform, and the partial signal is added to a front of the signal of the time domain. Note that, the CP may be a copy of a part of the front of the signal of the time domain and the copy may be added to the rear of the signal of the time domain. Note that, the CP may be a known sequence generated by a Golay code or the like. The OFDM signal generation unit a308-k outputs the generated OFDM signal to the transmission unit a309-k.

The transmission unit a309-k performs digital/analog conversion for the OFDM signal which is input from the OFDM signal generation unit a308-k, and performs waveform shaping of the converted analog signal. The transmission unit a309-k up-converts the signal subjected to the waveform shaping from a base band to a radio frequency band, to transmit to a reception apparatus b3 from the transmit antenna a1-k.

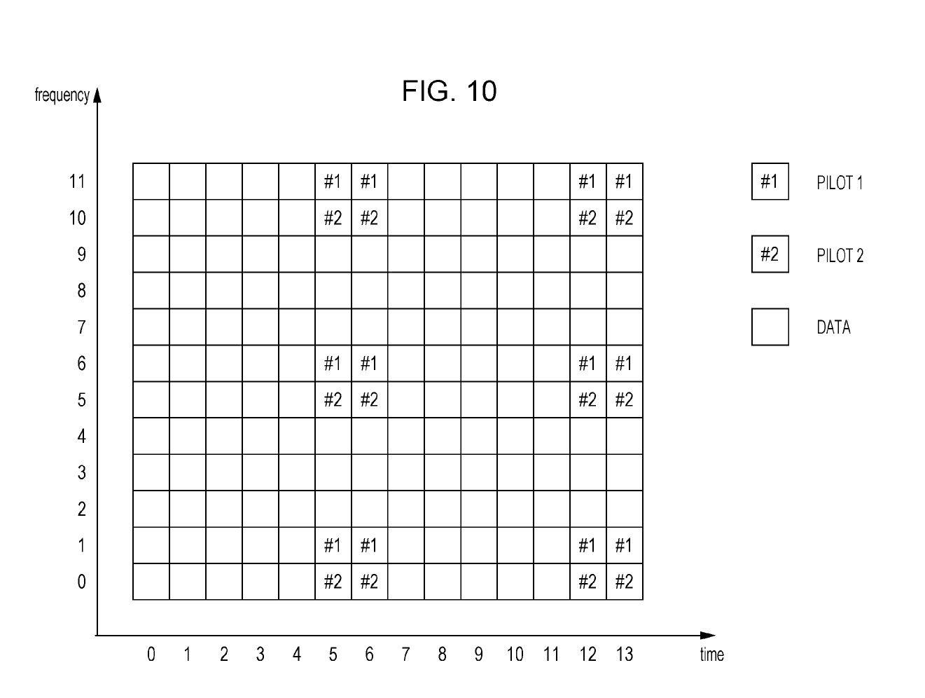

FIG. 10 is an example of outputs of the RE mapping unit a307-k. For example, in a case of N_{T}=8, it is possible that resource elements #1 are at pilot positions of K=1,2,5,7, and resource elements #2 are at pilot positions of K=3,4,6,8. The reception apparatus b3 is able to perform channel estimation by using received signals in the resource elements. A pilot symbol of each stream may be, for example, code-multiplexed.

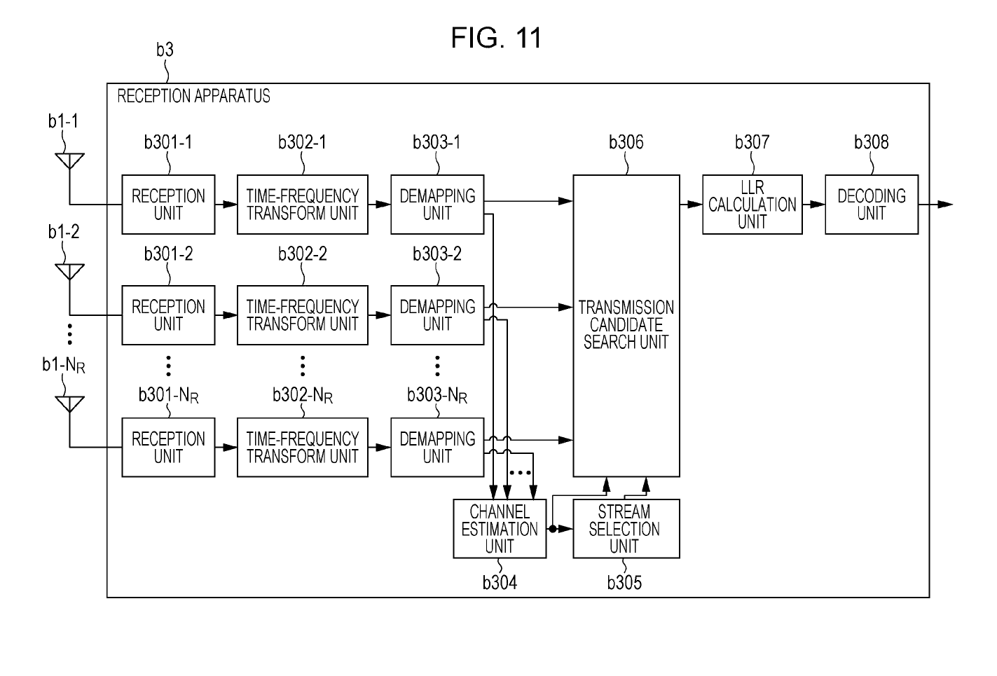

FIG. 11 is a schematic block diagram showing a configuration of the reception apparatus b3 according to the third embodiment of the invention. In the figure, the reception apparatus b3 is composed by including a reception unit b301-r, a time-frequency transform unit b302-r, a demapping unit b303-r, a channel estimation unit b304, a stream selection unit b305, a transmission candidate search unit b306, an LLR calculation unit b307, and a decoding unit b308. Here, r=1, . . . , N_{R}. Moreover, a receive antenna b1-r is illustrated together in FIG. 11.

The reception unit b301-r receives the OFDM transmission signal, which is transmitted by the transmission apparatus a3, through the receive antenna b1-r. The reception unit b301-r performs frequency transform and analog/digital conversion for the received signal. The reception unit b301-r outputs the received signal, which is transformed and converted, to the time-frequency transform unit b302-r.

The time-frequency transform unit b302-r removes CP from the received signal input from the reception unit b301-r. The time-frequency transform unit b302-r performs time-frequency transform for the signal from which the CP has been removed. Specifically, FFT (Fast Fourier Transform) is usable for the time-frequency transform. The time-frequency transform unit b302-r outputs the received signal of the frequency domain, which is transformed, to the demapping unit b303-r.

The demapping unit b303-r demultiplexes a resource element in which data is transmitted and a resource element in which a pilot symbol is transmitted, from the signal of the frequency domain input from the time-frequency transform unit b303-r. The demapping unit b303-r outputs, to the transmission candidate search unit b306, the received signal of the resource element in which the data is transmitted. The demapping unit b303-r outputs, to the channel estimation unit b304, the received signal of the resource element in which the pilot symbol is transmitted.

The channel estimation unit b304 performs channel estimation by using the received signal of the resource element in which the pilot symbol is transmitted, which is input from the demapping unit b303-r, and calculates a channel value. The channel estimation unit b304 outputs the calculated channel value to the stream selection unit b305 and the transmission candidate search unit b306.

The stream selection unit b305 selects linear streams and non-linear streams based on the channel value input from the channel estimation unit b304. The stream selection unit b305 outputs information of the selected linear streams and non-linear streams to the transmission candidate search unit b306.

Based on the information of the linear streams and the non-linear streams, which is input from the stream selection unit b305, the transmission candidate search unit b306 rearranges streams to be processed. Similarly to the first embodiment, streams of 1, . . . , N_{T} input from the demapping unit b303-r are rearranged so that first-half N_{T}−N_{K} pieces become linear streams and last-half N_{K} pieces become non-linear streams. Note that, this is one example and there is no limitation to such rearrangement.

The transmission candidate search unit b306 generates non-linear candidates serving as possible transmission candidates of N_{T}−N_{K}+1-th, N_{T}-th rearranged streams, that is, the non-linear streams.

The transmission candidate search unit b306 generates a linear detection signal based on the generated non-liner candidates. Specifically, before starting search of the non-linear candidates, normal linear detection which is not based on constraint by the non-linear candidates is performed to calculate a non-constrained linear detection signal. Note that, ZF or MMSE is usable for the normal linear detection. By correcting the non-constrained linear detection signal based on the generated non-linear candidates, the linear detection signal is able to be generated. Note that, for generating the linear detection signal, the received signal may be deformed based on the non-linear candidates to perform linear detection for the received signal which has been deformed. A canceller such as an SIC may be used for the linear detection.

The transmission candidate search unit b306 makes hard decision for the linear detection signal, generates transmission candidates of the linear streams, and combines the transmission candidates and corresponding non-linear candidates to thereby generate transmission candidates of all the streams.

The transmission candidate search unit b306 calculates a metric of each of the transmission candidates. The transmission candidate search unit b306 generates a constrained metric based on each of the transmission candidates and the metric thereof. The constrained metric will be explained specifically in operation principle described below. The transmission candidate search unit b306 selects the transmission candidate a metric of which is minimum and outputs the linear detection signal corresponding to the selected transmission candidate to the LLR calculation unit b307. Further, the transmission candidate search unit b306 outputs the constrained metric to the LLR calculation unit b307.

The LLR calculation unit b307 calculates an LLR of the linear streams by using the linear detection signal input from the transmission candidate search unit b306. The LLR calculation unit b307 calculates an LLR of the non-linear streams by using the constrained metric input from the transmission candidate search unit b306. The LLR calculation unit b307 outputs the calculated LLRs to the decoding unit b308.

The decoding unit b308 performs decoding processing based on the LLRs input from the LLR calculation unit b307 by using, for example, a maximum likelihood decoding method, maximum a posteriori probability (MAP), log-MAP, Max-log-MAP, SOVA (Soft Output Viterbi Algorithm) or the like.

### <About Operation Principle>

Operation principle of the reception apparatus b3 will be described below.

Description will be given for a case where the layer mapping unit a304 of FIG. 9 allocates inputs from the modulation unit a303-l to all of 1, . . . N_{T}. In this case, an N_{R}-th dimensional received signal vector in a certain element (a symbol number and a subcarrier number are omitted) is able to be represented by the formulas (1) to (4) similarly to the first embodiment. Note that, in the case of the present embodiment, yᵣ serves as an output of the demapping unit b303-r. When the streams allocated by the layer mapping unit a304 of FIG. 9 are not all of 1, . . . , N_{T}, but are in N_{U} pieces, the channel matrix of the formula (2) may be set as having N_{R} rows and N_{U} columns. The similar is applied also to the embodiments below.

Note that, the channel matrix represents an equivalent channel affected by precoding. By performing precoding also for a pilot symbol in the precoding unit a306 of FIG. 9, the reception apparatus b3 is able to estimate the equivalent channel without considering presence or absence of precoding.

When assuming that the channel matrix H was able to be estimated by the channel estimation unit b304, the formulas (5) to (28) of the first embodiment are able to be applied directly. The following is one example of a method for calculating an LLR by using results thereof.

A number of a non-linear candidate a metric of which calculated by the formula (28) is minimum is set as mₘᵢₙ. At this time, when a k-th rearranged stream is a linear stream, that is, k=1, . . . , N_{T}−N_{K}, the LLR of the k-th rearranged stream is able to be calculated by the following formulas (39) to (42). Here, λ(d_{k,q}) is an LLR of a q-th bit in the k-th rearranged stream.

$$[ Expression 26 ]$$

$$\begin{matrix}{μ}_{k} = {μ}_{{K}^{′} ( k ) , {N}_{K}} & ( 39 ) \\ {γ}_{k} = {[ {z}_{{K}^{′} , {m}_{min}} ]}_{k} & ( 40 ) \\ λ ( {d}_{k , 1} ) = \frac{4 Re [ {γ}_{k} ]}{\sqrt{2} ( 1 - {μ}_{k} )} & ( 41 ) \\ λ ( {d}_{k , 2} ) = \frac{4 Im [ {γ}_{k} ]}{\sqrt{2} ( 1 - {μ}_{k} )} & ( 42 )\end{matrix}$$

Moreover, K′(k) is a k-th element of K′. Note that, a right side of the formula (39) is of the formula (10), and a result of calculation of the formula (10) with the LLR calculation unit b307 is usable therefor. Further, [z_{K′m}]ₖ is a k-th element of z_{K′,m}. The formulas (41) and (42) serve as an LLR calculation method when the k-th rearranged stream uses QPSK. The calculation is able to be performed easily also in the case of not being QPSK. For example, when the k-th rearranged stream uses 16QAM, the calculation is able to be performed with the following formulas (43) to (46) by using the formulas (39) and (40).

$$[ Expression 27 ]$$

$$\begin{matrix}λ ( {d}_{k , 1} ) = \{ \begin{matrix}\frac{8}{\sqrt{10} ( 1 - {μ}_{k} )} ( Re [ {γ}_{k} ] - sign ( Re [ {γ}_{k} ] ) \frac{1}{\sqrt{10}} {μ}_{k} ) & ( \vert Re [ {γ}_{k} ] \vert \geq \frac{2}{\sqrt{10}} {μ}_{k} ) \\ \frac{4}{\sqrt{10} ( 1 - {μ}_{k} )} Re [ {γ}_{k} ] & ( \vert Re [ {γ}_{k} ] \vert < \frac{2}{\sqrt{10}} {μ}_{k} )\end{matrix} & ( 43 ) \\ λ ( {d}_{k , 2} ) = \frac{4}{\sqrt{10} ( 1 - {μ}_{k} )} ( \vert Re [ {γ}_{k} ] \vert < \frac{2}{\sqrt{10}} {μ}_{k} ) & ( 44 ) \\ λ ( {d}_{k , 3} ) = \{ \begin{matrix}\frac{8}{\sqrt{10} ( 1 - {μ}_{k} )} ( Im [ {γ}_{k} ] - sign ( Im [ {γ}_{k} ] ) \frac{1}{\sqrt{10}} {μ}_{k} ) & ( \vert Im [ {γ}_{k} ] \vert \geq \frac{2}{\sqrt{10}} {μ}_{k} ) \\ \frac{4}{\sqrt{10} ( 1 - {μ}_{k} )} Im [ {γ}_{k} ] & ( \vert Im [ {γ}_{k} ] \vert < \frac{2}{\sqrt{10}} {μ}_{k} )\end{matrix} & ( 45 ) \\ λ ( {d}_{k , 4} ) = \frac{4}{\sqrt{10} ( 1 - {μ}_{k} )} ( \vert Im [ {γ}_{k} ] \vert < \frac{2}{\sqrt{10}} {μ}_{k} ) & ( 46 )\end{matrix}$$

Here, sign( ) is a function which returns 1 when an argument is positive and returns −1 when it is negative.

Next, an LLR calculation method for a non-linear stream will be described. For calculating the LLR of the k-th rearranged stream, first, constrained metrics f(k,q,0) and f(k,q,1) are calculated. f(k,q,0) is the minimum metric when d_{k,q} is fixed to 0, and f(k,q,1) is the minimum metric when d_{k,q} is fixed to 1. At this time, the LLR is able to be calculated by the following formula (47).

[Expression]

λ(d_{k,q})=−σ²[f(k,q,0)−f(k,q,1)] (47)

The LLR of the linear stream may be also calculated by the formula (47). In the case of the linear stream, however, there is a case where either f(k,q,0) or f(k,q,1) does not exist. In such a case, an LLR calculation method, by which the LLR is calculated by the formula (47) when both constrained metrics exist, and the linear detection signal described above is used when any of the constrained metrics does not exist, may be used.

Note that, there is a case where different m has the same the metrics calculated by the formula (28). Accordingly, there is a case where a plurality pieces of mₘᵢₙ exist. For calculating the LLR of the linear streams in such a case, selection may be performed from the plurality pieces of mₘᵢₙ in a random manner or one which is calculated first may be selected. When mₘᵢₙ includes m=0, selection may be performed from other than m=0.

For calculating the LLR of the linear streams when mₘᵢₙ has only one of m=0, for example, it may be applied to the formulas (41) and (42) in the case of QPSK and to the formulas (43) to (46) in the case of 16QAM by using the following formulas (48) and (49).

$$[ Expression 29 ]$$

$$\begin{matrix}{μ}_{k} = {c}_{k}^{H} ( \begin{matrix}{C}_{{K}^{′}}^{H} \\ {C}_{K}^{H}\end{matrix} ) {PH}^{H} ( {C}_{{K}^{′}} {C}_{K} ) {c}_{k} & ( 48 ) \\ {γ}_{k} = {[ x ]}_{k} & ( 49 )\end{matrix}$$

Note that, [x]ₖ is a k-th element of x.

<About Operation of Reception Apparatus b3>

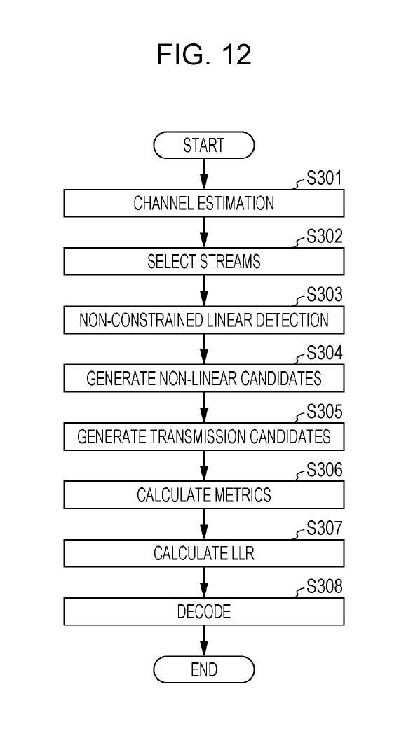

FIG. 12 is a flowchart illustrating an operation of the reception apparatus according to the present embodiment. Note that, the operation illustrated by the figure is processing after the demapping unit b303-r of FIG. 11 demultiplexed a received signal of a resource element in which data was transmitted and a received signal of a resource element in which a pilot symbol was transmitted.

(Step S301) The channel estimation unit b304 performs channel estimation based on the received signal of the resource element in which the pilot symbol was transmitted. Then, the procedure moves to step S302.

(Step S302) The stream selection unit b305 selects linear streams and non-linear streams based on a channel value obtained at step S301. Then, the procedure moves to step S303.

(Step S303) The transmission candidate search unit b306 performs non-constrained linear detection based on the channel value obtained at step S301. Then, the procedure moves to step S304.

(Step S304) The transmission candidate search unit b306 generates non-linear candidates. Then, the procedure moves to step S305.

(Step S305) The transmission candidate search unit b306 corrects a non-constrained linear detection signal, which is obtained at step S303, based on the non-linear candidates obtained at step S304, and generates a linear detection signal. The transmission candidate search unit b306 generates transmission candidates based on the linear detection signal. Then, the procedure moves to step S306.

(Step S306) The transmission candidate search unit b306 calculates metrics of the transmission candidates obtained at step S305. The transmission candidate search unit b306 outputs a linear detection signal corresponding to the transmission candidate a metric of which is minimum. The transmission candidate search unit b306 calculates a constrained metric. Then, the procedure moves to step S307.

(Step S307) The LLR calculation unit b307 calculates an LLR of the linear streams based on the linear detection signal corresponding to the transmission candidate a metric of which obtained at step S306 is minimum. The LLR calculation unit b307 calculates an LLR of the non-linear streams based on the constrained metric obtained at step S306. Then, the procedure moves to step S308.

(Step S308) The decoding unit b308 performs decoding by using the LLRs obtained at step S307. Then, the reception apparatus b3 ends the operation.

In this manner, according to the present embodiment, the linear streams and the non-linear streams are selected, non-linear detection is performed only for the non-linear streams, and the linear detection signal is calculated based on the non-linear candidates. By calculating the LLRs and performing decoding by using the calculated LLRs in this manner, it is possible to realize excellent transmission performances with a small amount of calculation.

### Fourth Embodiment

A fourth embodiment of the invention will be described below in detail with reference to drawings. In the third embodiment, the reception apparatus b3 calculates the LLR of the liner streams by using the transmission candidate a metric of which is minimum and calculates the LLR of the non-linear streams by using the constrained metric. In the present embodiment, a method for reducing an amount of calculation of searching transmission candidates by using QR decomposition will be described.

Note that, since a transmission apparatus according to the fourth embodiment of the invention has the same configuration as that of the transmission apparatus a3 according to the third embodiment, description thereof will be omitted.

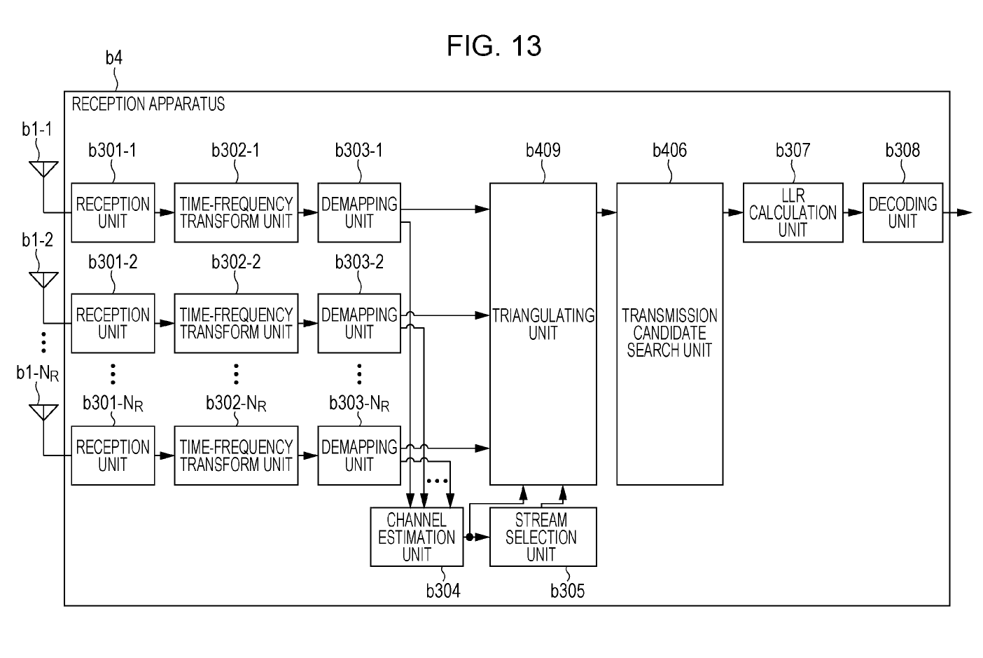

FIG. 13 is a schematic block diagram illustrating a configuration of a reception apparatus b4 according to the fourth embodiment of the invention. When comparing the reception apparatus b4 (FIG. 13) according to the present embodiment and the reception apparatus b3 (FIG. 11) according to the third embodiment, a transmission candidate search unit b406 is different and a triangulating unit b409 is newly included. However, functions that other components (the reception unit b301-r, the time-frequency transform unit b302-r, the demapping unit b303-r, the channel estimation unit b304, the stream selection unit b305, the LLR calculation unit b307, and the decoding unit b308) have are the same as those of the third embodiment. Description for the functions same as those of the third embodiment will be omitted.

The triangulating unit b406 performs QR decomposition of a channel value input from the channel estimation unit b304, based on information of linear streams and non-linear streams, which is input from the stream selection unit b305. The triangulating unit b409 uses a submatrix of a unitary matrix obtained as a result of the QR decomposition to perform orthogonal conversion of a received signal. This corresponds to an operation of triangulating a channel. The triangulating unit b409 outputs a triangulated received signal obtained by performing orthogonal conversion of the received signal to the signal candidate search unit b406.

The transmission candidate search unit b406 performs normal linear detection and generates a non-constrained linear detection signal. The transmission candidate search unit b406 calculates a metric of the non-constrained linear detection signal based on a hard-decision value for the non-constrained linear detection signal and the triangulated received signal which is input from the triangulating unit b409. The transmission candidate search unit b406 saves the metric as a reference metric and saves the hard-decision value for the non-constrained linear detection signal. Further, the transmission candidate search unit b406 calculates and saves a constrained metric corresponding to the hard decision.

The transmission candidate search unit b406 generates non-linear candidates serving as possible transmission candidates of N_{T}−N_{K}+1-th, N_{T}-th rearranged streams, that is, non-linear streams, which are non-linear candidates in which a cumulative metric of each rearrangement is below at least one of constrained metrics corresponding to the reference metric. The transmission candidate search unit b406 corrects the non-constrained linear detection signal based on the generated non-linear candidates to thereby generate a linear detection signal.

The transmission candidate search unit b406 makes hard decision for the linear detection signal, generates transmission candidates of the linear streams, and combines the transmission candidates and corresponding non-linear candidates to thereby generate transmission candidates of all the streams. The transmission candidate search unit b406 calculates metrics of the transmission candidates. When the generated metric is below the reference metric, the transmission candidate search unit b406 saves the generated metric as a new reference metric, and saves a bit sequence of the corresponding transmission candidate.

The transmission candidate search unit b406 performs the selection of the non-linear candidates, the generation of the non-linear detection signal and the updating of the metric, which are described above, until a non-linear candidate which is able to be selected does not exist.

### <About Operation Principle>

Operation principle of the reception apparatus b4 will be described below.

Similarly to the third embodiment, the formulas of the first embodiment are able to be applied directly when a multi-path delay does not exceed CP of an OFDM signal. For describing the present embodiment, the formulas (1) to (26) are used in common. In addition, the formulas (31) to (38) of the second embodiment are also able to be applied directly. A difference from the second embodiment is that a condition for selecting non-linear candidates is made lighter to calculate a constrained metric. This will be described together with an operation of the reception apparatus b4 described below.

<About Operation of Reception Apparatus b4>

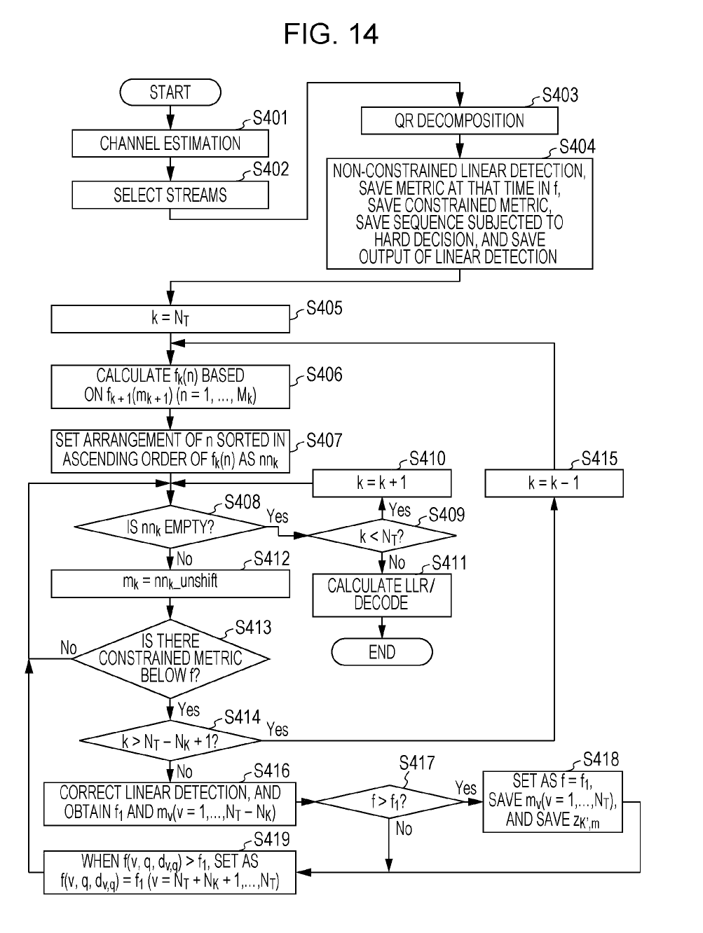

FIG. 14 is a flowchart illustrating an operation of the reception apparatus according to the present embodiment. Note that, the operation illustrated by the figure is processing after the demapping unit b303-r of FIG. 13 demultiplexed a received signal of a resource element in which data was transmitted and a received signal of a resource element in which a pilot symbol was transmitted.

(Step S401) The channel estimation unit b304 performs channel estimation based on the received signal of the resource element in which the pilot symbol was transmitted. Then, the procedure moves to step S402.

(Step S402) The stream selection unit b305 selects linear streams and non-linear streams based on a channel value obtained at step S401. Then, the procedure moves to step S403.

(Step S403) The triangulating unit b409 rearranges a channel matrix H in a column direction based on the linear streams and the non-linear streams obtained at step S402. At this time, rearrangement may be further performed among the linear streams and the non-linear streams. The triangulating unit b409 performs QR decomposition for the rearranged H. The triangulating unit b409 triangulates a received signal based on a result of the QR decomposition. Then, the procedure moves to step S404.

(Step S404) The transmission candidate search unit b406 performs non-constrained liner detection. A sequence obtained as a result thereof is subjected to hard decision and a metric at that time is calculated. The metric is saved in f as a reference metric. Further, a bit sequence thereof is saved. A constrained metric at that time is saved. The constrained metric saved at this time is f(v,q,d_{v,q}) with respect to an obtained bit sequence d_{v,q}(v=1, . . . , N_{T}). Then, the procedure moves to step S405.

(Step S405) It is set that k=N_{T}. Moreover, each variable is initialized. Then, the procedure moves to step S406.

(Step S406) A cumulative metric is calculated by using the formula (38) for all modulation symbols being used in the k-th rearranged stream. Then, the procedure moves to step S407.

(Step S407) n is extracted in an ascending order of fₖ(n) and saved in nnₖ. Then, the procedure moves to step S408.

(Step S408) When nnₖ is empty, the procedure moves to step S409. When not, the procedure moves to step S412.

(Step S409) When k is smaller than N_{T}, the procedure moves to step S410. When not, the procedure moves to step S411.

(Step S410) The procedure moves to step S408 after setting as k=k+1.

(Step S411) The LLR calculation unit b307 calculates an LLR of the linear streams based on the linear detection signal corresponding to the transmission candidate a metric of which is minimum. The LLR calculation unit b307 calculates an LLR of the non-linear streams by using the formula (47). Then, the reception apparatus b4 ends processing.

(Step S412) A value at the beginning of nnₖ is saved in mₖ. The value at the beginning is removed from nnₖ. Then, the procedure moves to step S413.

(Step S413) When there is a constrained metric below f, the procedure moves to step S414. When not, the procedure moves to step S408. Note that, specifically, one which is below f may be searched for from among ftv,q,d_{v,q}) because d_{v,q} has been determined for v=k, . . . , N_{T}, and one which is below f may be searched for from among f(v,q,0) and f(v,q,1) because d_{v,q} has not been determined for v=N_{T}−N_{K}+1, . . . , k−1.

(Step S414) When k is larger than N_{T}−N_{K}+1, the procedure moves to step S415. When not, the procedure moves to step S416.

(Step S415) The procedure moves to step S406 after setting as k=k−1.

(Step S416) By using mᵥ of v=N_{T}−N_{K}+1, . . . , N_{T}, which has been obtained, a linear detection signal is generated based on the formula (17). By hard decision for the linear detection signal, mᵥ of v=1, . . . , N_{T}, which has not been obtained, is obtained and a metric fₗ at that time is calculated. Then, the procedure moves to step S417.

(Step S417) When f is larger than fₗ, the procedure moves to step S418. When not, the procedure moves to step S419.

(Step S418) f is updated with fₗ. As a new sequence, mᵥ(v=1, . . . , N_{T}) is saved. Then, the procedure moves to step S419.

(Step S419) The constrained metric f(v,q,d_{v,q}) is updated (v=N_{T}−N_{K}+1, . . . , N_{T}).

In this manner, according to the present embodiment, by triangulating a channel by using QR decomposition, an amount of calculation of the LLR is able to be reduced significantly.

### Fifth Embodiment

A fifth embodiment of the invention will be described below with reference to drawings. In the fourth embodiment, a condition under which the transmission candidate search unit b406 selects non-linear candidates is made lighter so that the LLR of non-linear streams is able to be calculated by calculating a constrained metric even when an amount of calculation is reduced by QR decomposition. In the present embodiment, description will be given for a method for searching for only a small metric and a bit sequence thereof and calculating the LLR of the non-linear streams by using information thereof similarly to the second embodiment.

Note that, since a transmission apparatus according to the fifth embodiment of the invention has the same configuration as that of the transmission apparatus a3 according to the third embodiment, description thereof will be omitted.

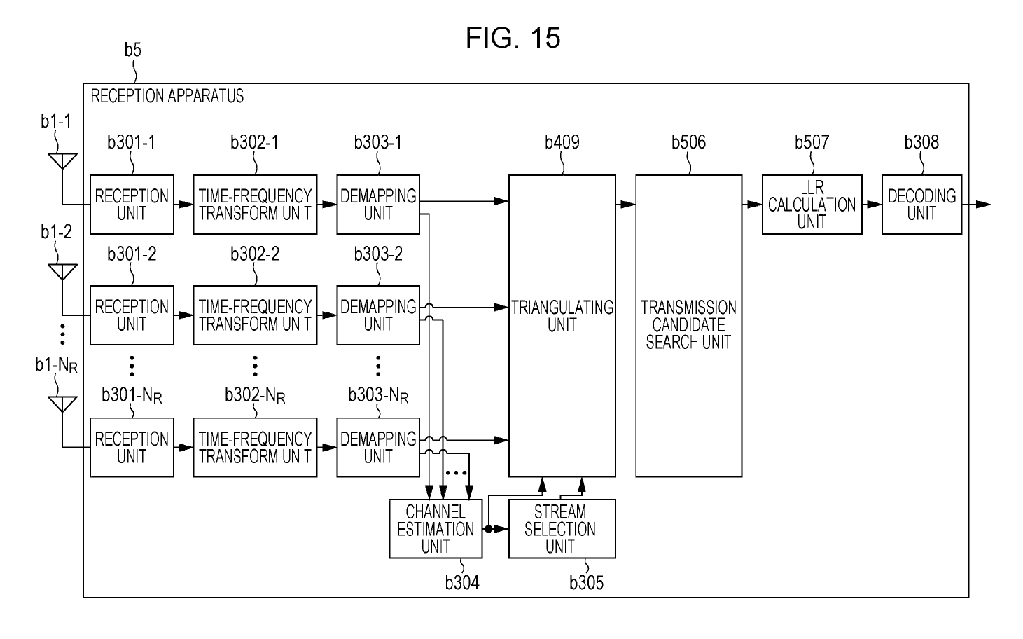

FIG. 15 is a schematic block diagram illustrating a configuration of a reception apparatus b5 according to the fifth embodiment of the invention. When comparing the reception apparatus b5 (FIG. 15) according to the present embodiment and the reception apparatus b4 (FIG. 13) according to the fourth embodiment, a transmission candidate search unit b506 and an LLR calculation unit b507 are different. However, functions that other components (the reception unit b301-r, the time-frequency transform unit b302-r, the demapping unit b303-r, the channel estimation unit b304, the stream selection unit b305, the decoding unit 308, and the triangulating unit b409) have are the same as those of the fourth embodiment. Description for the functions same as those of the fourth embodiment will be omitted.

The transmission candidate search unit b506 performs normal linear detection and generates a non-constrained linear detection signal. The transmission candidate search unit b506 calculates a metric of the non-constrained linear detection signal based on a hard-decision value for the non-constrained linear detection signal and a triangulated received signal which is input from the triangulating unit b506. The transmission candidate search unit b506 saves the metric as a reference metric and saves the hard-decision value for the non-constrained linear detection signal.

The transmission candidate search unit b506 generates non-linear candidates serving as possible transmission candidates of N_{T}−N_{K}+1-th, N_{T}-th rearranged streams, that is, non-linear streams, which are non-linear candidates in which a cumulative metric of each rearrangement is below the reference metric. The transmission candidate search unit b506 corrects the non-constrained linear detection signal based on the generated non-linear candidates to thereby generate a linear detection signal.

The transmission candidate search unit b506 makes hard decision for the linear detection signal, generates transmission candidates of the linear streams, and combines the transmission candidates and corresponding non-linear candidates to thereby generate transmission candidates of all the streams. The transmission candidate search unit b506 calculates a metric of the transmission candidates. When the generated metric is below the reference metric, the transmission candidate search unit b506 saves the generated metric as a new reference metric, saves a bit sequence of the corresponding transmission candidate, and saves a linear detection signal thereof.

The transmission candidate search unit b506 performs the selection of the non-linear candidates, the generation of the non-linear detection signal and the updating of the metric, which are described above, until a non-linear candidate which is able to be selected does not exist.

The LLR calculation unit b507 calculates an LLR of the linear streams by using the linear detection signal input from the transmission candidate search unit b506. The LLR calculation unit b507 calculates an LLR of the non-linear streams by using the metrics, the linear detection signal and the like, which are input from the transmission candidate search unit b506.

### <About Operation Principle>

Operation principle of the reception apparatus b5 will be described below.

In the fourth embodiment, since the LLR of the non-liner streams is calculated based on the formula (47), the constrained metrics are calculated without lacks. In the present embodiment, the bit sequence a metric of which is minimum and the linear detection signal are obtained like in the second embodiment. Therefore, there is a possibility that either the constrained metrics f(k,q,0) or f(k,q,1) lacks and the LLR of the non-linear streams may not be calculated. In the present embodiment, the LLR of non-linear streams is calculated with a method which does not depend on constrained metrics.

For example, the LLR of the non-linear streams is able to be calculated as the following formula (50) by using an average value of magnitude of the LLR of linear streams.

[Expression 30]

λ(d_{k,q})=λₐᵥₑ(1−2d_{k,q}) (50)

Here, k=N_{T}−N_{K}+1, . . . , N_{T}. d_{k,q} has been determined by the transmission candidate search unit b506. Further, λₐᵥₑ is an average value represented by the following formula (51).

$$[ Expression 31 ]$$

$${λ}_{ave} = \frac{1}{{N}_{T} - {N}_{K}} {\sum }_{k = 1}^{{N}_{T} - {N}_{K}} \vert λ ( {d}_{k , q} ) \vert \qquad ( 51 )$$

Note that, λₐᵥₑ may be set as an average value in a plurality of resource elements.

Moreover, by calculating a linear detection signal of the non-linear streams similarly to the linear streams, the LLR may be calculated with use of equivalent amplitude. First, the linear detection signal of the non-linear streams is represented by the following formulas (52) and (53).

[Expression 32]

z_{K,m}_{ₘᵢₙ}=x_{K}+U_{K′}(b_{K′,m}_{ₘᵢₙ}−x_{K′}) (52)

U_{K′}=C_{K}^{H}PC_{K′}(C_{K′}^{H}PC_{K′})⁻¹ (53)

The LLR of the non-linear streams is able to be calculated by assigning the following formulas (54) and (55) to the formulas (41) and (42) in the case of QPSK and the formulas (43) to (46) in the case of 16QAM.

$$[ Expression 33 ]$$

$$\begin{matrix}{μ}_{k} = {c}_{k}^{H} {C}_{K}^{H} {{H}^{H} ( {\sum }_{v ∈ K} {h}_{v} {h}_{v}^{H} + {σ}_{n}^{2} {I}_{{N}_{R}} )}^{- 1} {HC}_{K} {c}_{k} & ( 54 ) \\ {γ}_{k} = {[ {z}_{K , {m}_{min}} ]}_{k} & ( 55 )\end{matrix}$$

It is possible to perform the calculation similarly also in the case of other modulation schemes.

<About Operation of Reception Apparatus b5>

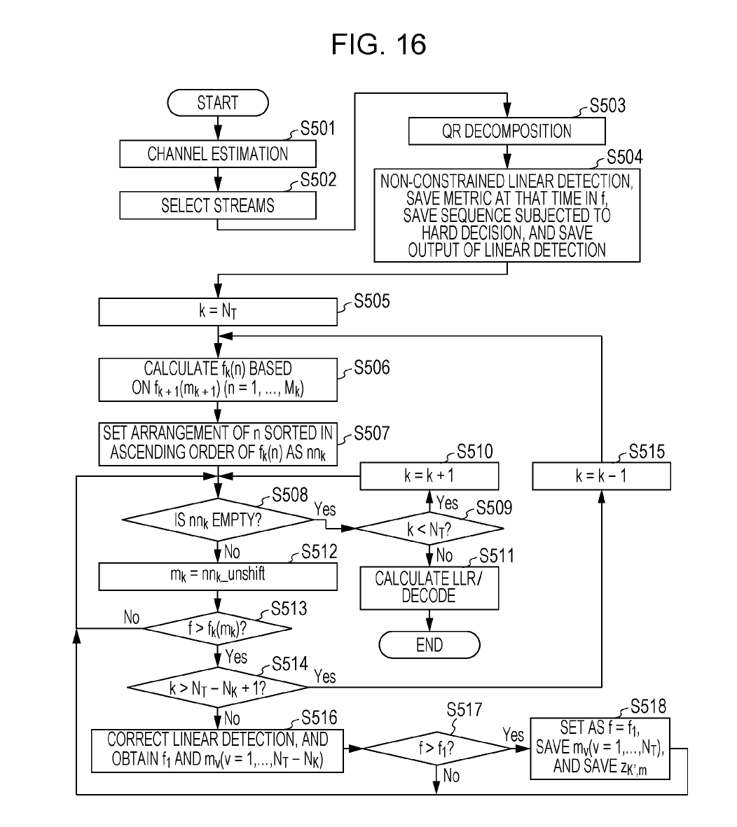

FIG. 16 is a flowchart illustrating an operation of the reception apparatus according to the present embodiment. Note that, the operation illustrated by the figure is processing after the demapping unit b303-r of FIG. 15 demultiplexed a received signal of a resource element in which data was transmitted and a received signal of a resource element in which a pilot symbol was transmitted.

(Step S501) The channel estimation unit b304 performs channel estimation based on the received signal of the resource element in which the pilot symbol was transmitted. Then, the procedure moves to step S502.

(Step S502) The stream selection unit b305 selects linear streams and non-linear streams based on a channel value obtained at step S501. Then, the procedure moves to step S503.

(Step S503) The triangulating unit b409 rearranges a channel matrix H in a column direction based on the linear streams and the non-linear streams obtained at step S502. At this time, rearrangement may be further performed among the linear streams and the non-linear streams. The triangulating unit b409 performs QR decomposition for the rearranged H. The triangulating unit b409 triangulates a received signal based on a result of the QR decomposition. Then, the procedure moves to step S504.

(Step S504) The transmission candidate search unit b506 performs non-constrained linear detection. Hard decision is made for a sequence obtained as a result thereof and a metric at that time is calculated. The metric is saved in f as a reference metric. Further, a bit sequence thereof is saved. Then, the procedure moves to step S505.

(Step S505) It is set as k=N_{T}. Further, each variable is initialized. Then, the procedure moves to step S506.

(Step S506) A cumulative metric is calculated by using the formula (38) with respect to all modulation symbols which is being used in a k-th rearranged stream. Then, the procedure moves to step S507.

(Step S507) n is extracted in an ascending order of fₖ(n) and saved in nnₖ. Then, the procedure moves to step S508.

(Step S508) When nnₖ is empty, the procedure moves to step S509. When not, the procedure moves to step S512.

(Step S509) When k is smaller than N_{T}, the procedure moves to step S510. When not, the procedure moves to step S511.

(Step S510) The procedure moves to step S508 after setting as k=k+1.

(Step S511) The LLR calculation unit b307 calculates an LLR of the linear streams based on the linear detection signal corresponding to the transmission candidate a metric of which is minimum. The LLR calculation unit b307 calculates an LLR of the non-linear streams by using the formula (50), the formulas (54) and (55), and the like. The decoding unit b308 performs decoding by using the LLRs. Then, the reception apparatus b5 ends processing.

(Step S512) A value at the beginning of nnₖ is saved in mₖ. The value at the beginning is removed from nnₖ. Then, the procedure moves to step S513.

(Step S513) When f is larger than fₖ(mₖ), the procedure moves to step S514. When not, the procedure moves to step S508.

(Step S514) When k is larger than N_{T}−N_{K}+1, the procedure moves to step S515.

When not, the procedure moves to step S516.

(Step S515) The procedure moves to step S506 after setting as k=k−1.

(Step S516) By using of v=N_{T}−N_{K}+1, . . . , N_{T}, which has been obtained, a linear detection signal is generated based on the formula (17). By hard decision for the linear detection signal, mᵥ of v=1, . . . , N_{T}, which has not been obtained, is obtained and a metric fₗ at that time is calculated. Then, the procedure moves to step S517.

(Step S517) When f is larger than fₗ, the procedure moves to step S518. When not, the procedure moves to step S508.

(Step S518) f is updated with fₗ. As a new sequence, mᵥ (v=1, . . . , N_{T}) is saved. Then, the procedure moves to step S508.

In this manner, according to the present embodiment, the transmission candidate search unit b506 selects non-linear candidates a cumulative metric of which is below the reference metric and calculates LLRs, thus making it possible to reduce an amount of calculation.

Note that, though description has been given in the fifth embodiment for a case where the LLR of the non-linear streams is calculated without using a constrained metric, the constrained metric may be used. For example, in the flowchart of FIG. 16, a new step (for example, step S519) is created after an output of No at step S517 and an output at step S518 so that f(v,q,d_{v,q}) is updated with respect to v=N_{T}−N_{K}+1, . . . , N_{T}. However, this may cause a case where any of final f(k,q,0) and f(k,q,1) (k=N_{T}−N_{K}+1, . . . , N_{T}) lacks due to step S513. By calculating the constrained metric which is lacking with another means, an LLR is able to be calculated. For example, the constrained metric which is lacking is able to be calculated by fixing a bit of a stream which is lacking, generating candidates with a similar method to the generation of the linear detection signal performed by the transmission candidate search unit b506, and calculating metrics.

### Sixth Embodiment

A sixth embodiment of the invention will be described specifically with reference to drawings. In the present embodiment, a method for iterating signal detection and decoding will be described.

Note that, since a transmission apparatus according to the sixth embodiment of the invention has the same configuration as that of the transmission apparatus a3 according to the third embodiment, description thereof will be omitted.

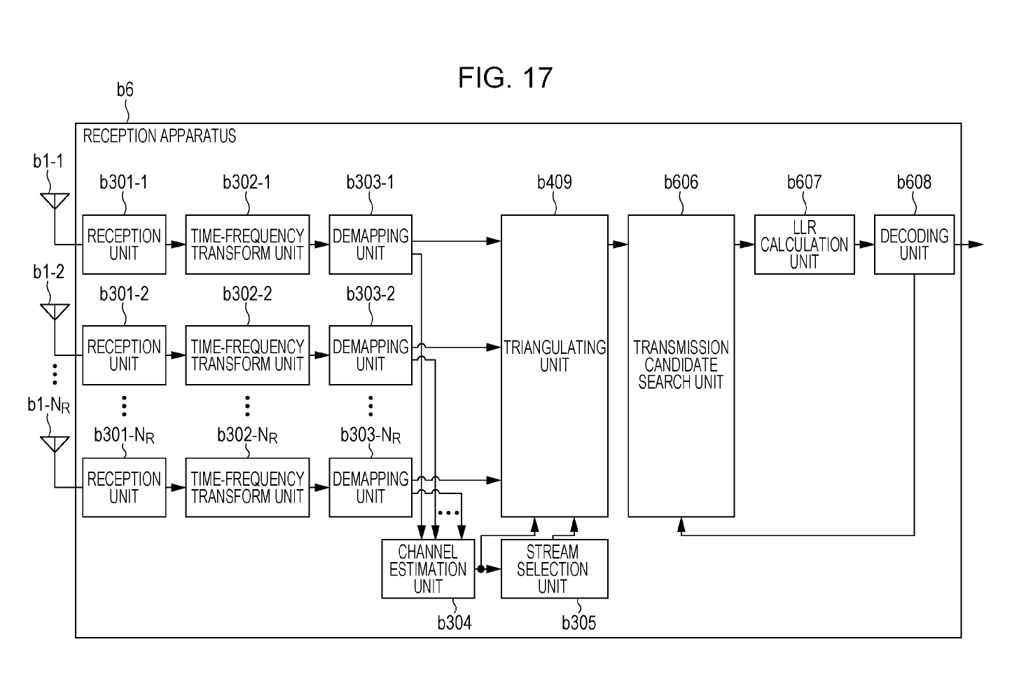

FIG. 17 is a schematic block diagram illustrating a configuration of a reception apparatus b6 according to the sixth embodiment of the invention. When comparing the reception apparatus b6 (FIG. 17) according to the invention and the reception apparatus b4 (FIG. 13) according to the fourth embodiment, a transmission candidate search unit b606, an LLR calculation unit b607, and a decoding unit b608 are different. However, functions that other components (the reception unit b301-r, the time-frequency transform unit b302-r, the demapping unit b303-r, the channel estimation unit b304, the stream selection unit b305, and the triangulating unit b409) have are the same as those of the fourth embodiment. Description for the functions same as those of the fourth embodiment will be omitted.

At the first time, the transmission candidate search unit b606, the LLR calculation unit b607 and the decoding unit b608 operate similarly to the fourth embodiment. Note that, the operation may be the same as that of the fifth embodiment. When no error is detected in a decoding result of the decoding unit b608 as a result of the first processing, a decoded bit is output and processing ends. When error is detected, the decoding unit b608 outputs an LLR of a coded bit to the transmission candidate search unit b606 to shift to iterative processing. Specifically, the LLR to be output may be obtained by subtracting an LRR which is input from the LLR calculation unit b607 from the decoding result. The iterative processing will be described below.

The transmission candidate search unit b606 updates the LLR of the non-linear streams by using the LLR of the coded bit, which is input from the decoding unit b608. The transmission candidate search unit b606 calculates the LLR in order of t=N_{T}, . . . , N_{T}−N_{K}+1.

First, the transmission candidate search unit b606 deforms a metric of non-constrained linear detection, which is obtained by the first processing, based on t and prior information input from the decoding unit b608. The deformed metric is saved as a reference metric. The transmission candidate search unit b606 calculates and saves a constrained metric corresponding thereto.

The transmission candidate search unit b606 generates non-linear candidates serving as possible transmission candidates of N_{T}−N_{K}+1-th, N_{T}-th rearranged streams, that is, non-linear streams, which are non-linear candidates in which a cumulative metric of each rearrangement is below the reference metric and the constrained metric corresponding to t. Note that, t and prior information input from the decoding unit b608 are used for calculation of the cumulative metric. The transmission candidate search unit b606 corrects the non-constrained linear detection signal based on the generated non-linear candidates to thereby generate a linear detection signal.

The transmission candidate search unit b606 makes hard decision for the linear detection signal, generates transmission candidates of the linear streams, and combines the transmission candidates and corresponding non-linear candidates to thereby generate transmission candidates of all the streams. The transmission candidate search unit b606 calculates a metric of the transmission candidates. For calculation of the metric, t and prior information input from the decoding unit b608 are used. When the generated metric is below the constrained metric corresponding to t, the transmission candidate search unit b606 saves the generated metric as a new constrained metric.

The transmission candidate search unit b606 performs the selection of the non-linear candidates, the generation of the linear detection signal and the updating of the constrained metric, which are described above, until a non-linear candidate which is able to be selected does not exist. When the updating of the constrained metric ends, t is set to another non-linear stream and similar processing is performed.

The LLR calculation unit b607 calculates the LLR of the non-linear streams by using the constrained metric input from the transmission candidate search unit b606. The LLR calculation unit b607 outputs the calculated LLR to the decoding unit b608.

The decoding unit b608 performs decoding similarly to the first processing.

The search of the transmission candidates, the calculation of the LLR, and the decoding are iterated until no error detected or a maximum number of times of iteration which is defined in advance is reached. Note that, for example, the maximum number of times of iteration may be fixed at a stage where the reception apparatus b6 is designed or may be updated when firmware or software of the reception apparatus b6 is updated.

### <About Operation Principle>

Operation principle of the reception apparatus b6 will be described below.

When there is prior information of a t-th rearranged stream, the LLR is able to be calculated by setting constrained metrics f(t,q,0) and t(t,q,1) as the following formulas (56) and (57).

$$[ Expression 34 ]$$

$$\begin{matrix}f ( t , q , 0 ) = {min}_{{d}_{t , q} = 0} [ {‖ {y}^{′} - {Rb}_{m} ‖}^{2} - {σ}^{2} {\sum }_{k = 1 , k \neq t}^{{N}_{T}} logp ( {m}_{k} ) ] & ( 56 ) \\ f ( t , q , 1 ) = {min}_{{d}_{t , q} = 0} [ {‖ {y}^{′} - {Rb}_{m} ‖}^{2} - {σ}^{2} {\sum }_{k = 1 , k \neq t}^{{N}_{T}} logp ( {m}_{k} ) ] & ( 57 )\end{matrix}$$

Here, log p(mₖ) is able to be calculated from the LLR input from the decoding unit b608. In the present embodiment, in the search of the transmission candidates using QR decomposition, the cumulative metric is calculated based on the formulas (56) and (57) and the LLR of the non-linear streams is updated, thus making it possible to improve accuracy of the LLR.

<About Operation of Reception Apparatus b6>

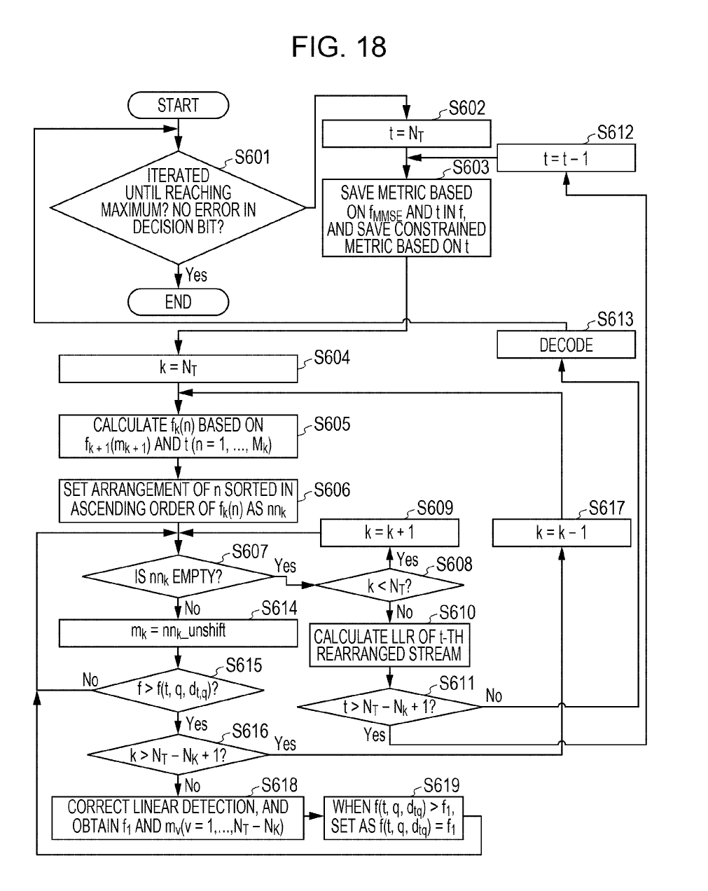

FIG. 18 is a flowchart illustrating an operation of the reception apparatus according to the present embodiment. Note that, the operation illustrated by the figure is processing after the decoding unit b608 of FIG. 17 performed decoding of the first processing.

(Step S601) The decoding unit b608 detects whether there is error in a decoding result or the number of times of iteration reaches a maximum value. When the result is true, the procedure moves to step s602. When not, the reception apparatus b6 ends processing.

(Step sS602) The rearranged stream t, the LLR of which is to be calculated, is set to N_{T}. Then, the procedure moves to step S603.

(Step sS603) A metric based on f_{MMSE} and t is saved in f as a reference metric. Specifically, the metric represented by the following formula (58) is saved.

[Expression 35]

∥y′−RDec[x]∥²−σ² log p(Dec[x]) (58)

Here, a first term of the formula (58) is f_{MMSE} of the formula (36). A result of the formula (58) is saved in f(t,q,d_{t,q}=Dec[x]ₜ) based on a hard-decision value Dec[x]. Then, the procedure moves to step S604.

(Step S604) It is set that k=N_{T}. Moreover, each variable is initialized. Then, the procedure moves to step S605.

(Step S605) The cumulative metric in consideration of prior information is calculated for all modulation symbols used in the k-th rearranged stream. Specifically, it is possible to represent by the following formulas (59) and (60).

$$[ Expression 36 ]$$

$$\begin{matrix}{f}_{k} ( n ) = \{ \begin{matrix}{f}_{k + 1} ( {m}_{k + 1} ) + {\vert {y}_{k}^{′} - {r}_{kk} {b}_{k} ( n ) - {\sum }_{v = k + 1}^{{N}_{T}} {r}_{kv} {b}_{v} ( {m}_{v} ) \vert}^{2} + {f}_{t , k , n}^{′} & ( k < {N}_{T} ) \\ {\vert {y}_{k}^{′} - {r}_{kk} {b}_{k} ( n ) \vert}^{2} + {f}_{t , k , n}^{′} & ( k = {N}_{T} )\end{matrix} & ( 59 ) \\ {f}_{t , k , n}^{′} ( n ) = \{ \begin{matrix}- {σ}^{2} log p ( {m}_{k} = n ) & ( k \neq t ) \\ 0 & ( k = t )\end{matrix} & ( 60 )\end{matrix}$$

Here, f′_{t,k,n} is prior information of the k-th rearranged stream. Then, the procedure moves to step S606.

(Step S606) n is extracted in an ascending order of fₖ(n) and saved in nnₖ. Then, the procedure moves to step S607.

(Step S607) When nnₖ is empty, the procedure moves to step S608. When not, the procedure moves to step S614.

(Step S608) When k is smaller than N_{T}, the procedure moves to step S609. When not, the procedure moves to step S610.

(Step S609) The procedure moves to step S607 after setting as k=k+1.

(Step S610) The LLR calculation unit b607 calculates the LLR of the k-th rearranged stream based on the constrained metrics f(t,q,0) and f(t,q,1) and the formula (47). Then, the procedure moves to step S611.

(Step S611) When t is larger than N_{T}−N_{K}+1, the procedure moves to step S612. When not, the procedure moves to step S613.

(Step S612) The procedure moves to step S603 after setting as t=t−1.

(Step S613) The decoding unit b608 performs decoding by using the LLR obtained at step S610. Then, the procedure moves to step S601.

(Step S614) A value at the beginning of nnₖ is saved in mₖ. The value at the beginning is removed from nnₖ. Then, the procedure moves to step S615.

(Step S615) When f is larger than the constrained metric f(t,q,d_{t,q}) of the t-th rearranged stream, the procedure moves to step S616. When not, the procedure moves to step S617. Note that, in a case where d_{t,q} is not determined with k>t, when f is larger than either f(t,q,0) or f(t,q,1), the procedure moves to step S616. When not, the procedure moves to step S607.

(S616) When k is larger than N_{T}−N_{K}+1, the procedure moves to step S617. When not, the procedure moves to step S618.

(Step S617) The procedure moves to step S605 after setting as k=k−1.

(Step S618) By using of v=N_{T}−N_{K}+1, . . . , N_{T}, which has been obtained, a linear detection signal is generated based on the formula (17). By hard decision for the linear detection signal, mᵥ of v=1, . . . , N_{T}, which has not been obtained, is obtained and a metric fₗ at that time is calculated. Then, the procedure moves to step S619.

(Step S619) The constrained metric f(t,q,d_{t,q}) is updated. Then, the procedure moves to step S607.

In this manner, according to the present embodiment, by iterating signal detection and decoding, transmission performances are able to be improved significantly.

Note that, though reception processing on the premise of QR decomposition has been described in the sixth embodiment, a case where QR decomposition is not used may be applied to like the third embodiment.

Note that, though a case where linear streams and non-linear streams similar to those of first processing are used also in iterative processing has been described in the sixth embodiment, they may be changed. For example, streams in which an average value of magnitude of the LLR is small as a result of decoding may be set as non-linear streams. In addition, the number of non-linear streams N_{K} may be reduced.

A program which is operated in the transmission apparatuses a1 and a3 and the reception apparatuses b1, b2, b3, b4 and b5 related to the invention is a program which controls a CPU and the like (program that causes a computer to function) so as to realize functions of the aforementioned embodiments related to the invention. In addition, information which is handled by the apparatuses is temporarily accumulated in a RAM at the time of processing thereof, and then stored in various ROMs or an HDD, and is read, modified, and written by the CPU as necessary. A recording medium that stores the program may be any of a semiconductor medium (for example, a ROM, a nonvolatile memory card or the like), an optical recording medium (for example, a DVD, an MO, an MD, a CD, a BD or the like), a magnetic recording medium (for example, a magnetic tape, a flexible disc or the like), or the like. Moreover, there is a case where, by executing the loaded program, not only the functions of the embodiments described above are realized, but also by performing processing in cooperation with an operating system, other application programs or the like based on an instruction of the program, the functions of the invention are realized.

When being distributed in the market, the program is able to be stored in a portable recording medium and distributed or be transferred to a server computer connected through a network such as the Internet. In this case, a storage device of the server computer is also included in the invention. A part or all of the transmission apparatuses a1 and a3 and the reception apparatuses b1, b2, b3, b4 and b5 explained by using the diagrams in the embodiments described above may be realized as an LSI which is a typical integrated circuit. Each functional block of the transmission apparatuses a1 and a3 and the reception apparatuses b1, b2, b3, b4 and b5 may be individually formed into a chip, or a part or all thereof may be integrated and formed into a chip. Further, a method for making into an integrated circuit is not limited to the LSI and a dedicated circuit or a versatile processor may be used for realization. Further, in a case where a technique for making into an integrated circuit in place of the LSI appears with advance of a semiconductor technology, an integrated circuit by the technique may be also used.

As above, the embodiments of the invention have been described in detail with reference to drawings, but specific configurations are not limited to the embodiments, and a design change and the like within a scope which is not departed from the main subject of the invention are also included. The invention can be modified variously within the scope defined by the claims, and embodiments obtained by appropriately combining technical means disclosed in different embodiments are also included in the technical scope of the invention. The configuration in which elements described in each of the aforementioned embodiments and achieving similar effects are replaced with each other is also included.

Note that, the invention of the present application is not limited to the embodiments described above. For example, a reception apparatus of the invention of the present application is applicable to satellite communication. Further, the terminal apparatus of the invention of the present application is not limited to be applied to a mobile station apparatus, but, needless to say, is applicable to stationary or unmovable electronic equipment which is installed indoors or outdoors such as, for example, AV equipment, kitchen equipment, a cleaning/washing machine, air conditioning equipment, office equipment, an automatic vending machine, and other domestic equipment.

### INDUSTRIAL APPLICABILITY

The invention is suitably used for a reception apparatus, a reception method and a reception program.

### DESCRIPTION OF REFERENCE NUMERALS

401, 402, 403, 404 modulation point of QPSK
801 square submatrix on left side of wide channel matrix
802 submatrix on right side of wide channel matrix
803 unitary matrix obtained by performing QR decomposition of 801
804 triangular matrix obtained by performing QR decomposition of 801
805 matrix obtained by adding zero matrix to right side of 803
806 matrix obtained by multiplying 802 by complex conjugate transpose of 803
807 matrix obtained by adding 806 to right side of 804
808 matrix obtained by adding zero matrix to lower side of 807
a1, a3 transmission apparatus
a1-k transmit antenna
b1, b2, b3, b4, b5, b6 reception apparatus
b1-r receive antenna
a101, a301 SP conversion unit
a102-k, a303-l modulation unit
a103, a305 pilot generation unit
a104-k mapping unit
a105-k, a309-k transmission unit
a302-l coding unit
a304 layer mapping unit
a306 precoding unit
a307-k RE mapping unit
a308-k OFDM signal generation unit
b101-r, b301-r reception unit
b102-r, b303-r demapping unit
b103, b304 channel estimation unit
b104, b305 stream selection unit
b105, b205, b306, b406, b506, b606 transmission candidate search unit
b206, b409 triangulating unit
b302-r time-frequency transform unit
b307, b507, b607 LLR calculation unit
b308, b608 decoding unit

1-18. (canceled)

19. A reception apparatus that receives a transmission signal, which is transmitted from a transmission apparatus by using a MIMO transmission scheme, comprising:
a stream selection unit that divides streams transmitted by the transmission apparatus into a first stream group and a second stream group; and
a transmission candidate search unit that generates at least one candidate of the first stream group, generates a linear detection signal of the second stream group based on the candidate of the first stream group to generate transmission candidates, calculates metrics of the transmission candidates, and selects a transmission candidate, a metric of which is minimum, of the transmission candidates.

20. The reception apparatus according to claim 19, wherein
the transmission candidate search unit generates a non-constrained linear detection signal which is a linear detection result using only the second stream group, and
corrects the non-constrained linear detection signal based on the candidate of the first stream group to thereby generate the linear detection signal.

21. The reception apparatus according to claim 19, comprising:
a triangulating unit that triangulates a channel matrix by performing orthogonal conversion, wherein
the transmission candidate search unit successively performs generation of the candidate of the first stream group, generation of the linear detection signal, and calculation of the metrics, and
generates a candidate of the first stream group, which is a candidate of the first stream group and a cumulative metric of which is smaller than the metrics obtained by earlier successive search.

22. The reception apparatus according to claim 21, wherein in a case of generating a predetermined number of candidates of the first stream group, the transmission candidate search unit ends the successive search.

23. The reception apparatus according to claim 19, wherein reduction of interference is performed for a received signal before performing reception processing.

24. The reception apparatus according to claim 19, wherein
the stream selection unit
selects, as the first stream group, a predetermined number of streams whose amplitude after linear detection is small.

25. The reception apparatus according to claim 19, wherein
the stream selection unit
selects, as the first stream group, a predetermined number of streams whose diagonal components of an inverse matrix of a correlation matrix of a received signal are large.

26. The reception apparatus according to claim 19, wherein
the stream selection unit
performs selection so that the number of candidates of the second stream group is smaller than the number of candidates of the first stream group.

27. The reception apparatus according to claim 19, wherein
the stream selection unit
performs selection so that the number of candidates of the second stream group is larger than the number of candidates of the first stream group.

28. The reception apparatus according to claim 19, comprising:
an LLR calculation unit that calculates a bit log likelihood ratio, and
a decoding unit that performs decoding by using the bit log likelihood ratio, wherein
the LLR calculation unit
calculates a bit log likelihood ratio of the second stream group based on amplitude after linear detection and a linear detection signal of the second stream group, and
calculates a bit log likelihood ratio of the first stream group based on an average value of magnitude of the bit log likelihood ratio of the second stream group and the candidate of the first stream group.

29. The reception apparatus according to claim 19, comprising:
an LLR calculation unit that calculates a bit log likelihood ratio, and
a decoding unit that performs decoding by using the bit log likelihood ratio, wherein
the LLR calculation unit
calculates a bit log likelihood ratio of the second stream group based on amplitude after linear detection and a linear detection signal of the second stream group,
generates a linear detection signal of the first stream group, and
calculates a bit log likelihood ratio of the first stream group based on amplitude after linear detection and the linear detection signal of the first stream group.

30. The reception apparatus according to claim 19, comprising:
an LLR calculation unit that calculates a bit log likelihood ratio, and
a decoding unit that performs decoding by using the bit log likelihood ratio, wherein
the transmission candidate search unit calculates a constrained metric of the transmission candidates, which is a minimum metric in a case where one bit in one stream is fixed, and
the LLR calculation unit
calculates a bit log likelihood ratio of the second stream group based on amplitude after linear detection and a linear detection signal of the second stream group, and
calculates a bit log likelihood ratio of the first stream group based on the constrained metric.

31. The reception apparatus according to claim 30, comprising
a triangulating unit that triangulates a channel matrix by performing orthogonal conversion, wherein
the transmission candidate search unit successively performs generation of the candidate of the first stream group, generation of the linear detection signal, and calculation of the metrics,
generates a candidate of the first stream group, which is a candidate of the first stream group and in which at least one of associated constrained metrics is smaller than the metrics obtained by earlier successive search, and
updates a constrained metric, which is a constrained metric associated with a bit sequence of the generated candidate of the first stream group and in which a metric of the generated candidate of the first stream group is smaller than the constrained metric, with the metric of the generated candidate of the first stream group.

32. A reception method for receiving a transmission signal, which is transmitted from a transmission apparatus by using a MIMO transmission scheme, comprising:
a stream selection step of dividing streams transmitted by the transmission apparatus into a first stream group and a second stream group; and
a transmission candidate search step of generating at least one candidate of the first stream group, generating a linear detection signal of the second stream group based on the candidate of the first stream group to generate transmission candidates, calculating metrics of the transmission candidates, and selecting a transmission candidate, a metric of which is minimum, of the transmission candidates.

33. The reception method according to claim 32, comprising:
an LLR calculation step of calculating a bit log likelihood ratio, and
a decoding step of performing decoding by using the bit log likelihood ratio, wherein
at the transmission candidate search step, a constrained metric of the transmission candidates, which is a minimum metric in a case where one bit in one stream is fixed, is calculated, and
at the LLR calculation step,
a bit log likelihood ratio of the second stream group is calculated based on amplitude after linear detection and a linear detection signal of the second stream group, and
a bit log likelihood ratio of the first stream group is calculated based on the constrained metric.

34. The reception method according to claim 33, comprising
a triangulating step of triangulating a channel matrix by performing orthogonal conversion, wherein
at the transmission candidate search step, generation of the candidate of the first stream group, generation of the linear detection signal, and calculation of the metrics are performed successively,
a candidate of the first stream group, which is a candidate of the first stream group and in which at least one of associated constrained metrics is smaller than the metrics obtained by earlier successive search, is generated, and
a constrained metric, which is a constrained metric associated with a bit sequence of the generated candidate of the first stream group and in which a metric of the generated candidate of the first stream group is smaller than the constrained metric, is updated with the metric of the generated candidate of the first stream group.

35. The reception method according to claim 33, wherein
a series of processing that
a coded bit log likelihood ratio is calculated at the decoding step,
a constrained metric of the transmission candidates is calculated based on the coded bit log likelihood ratio at the transmission candidate search step, and
a bit log likelihood ratio is calculated by using the constrained metric at the LLR calculation step
is iterated by a predetermined number of times.

36. A non-transitory computer-readable medium including a computer program for performing, when the computer program runs on a computer, a receiving method for causing a computer to execute the reception method according to claim 32.
